(19) United States
(12) Patent Application Publication
(10) Pub. No.: US 2003/0028477 A1
(43) Pub. Date: Feb. 6, 2003

(54) Automated method and system for consumer financial counseling

(75) Inventors: D. William Stevenson, Windermere, FL (US); Randy G. Melton, Orlando, FL (US); Michael S. Wilson, Longwood, FL (US); Elsa C. Wood, Winter Park, FL (US)

Correspondence Address: Jeffrey C. Maynard, Esq., Whiteford Taylor & Preston, LLP, Seven St. Paul Street, Baltimore, MD, 21201-1626, US

(73) Assignee: Accredited Bankruptcy Services, Inc., Orlando, FL (US)

(21) Appl. No.: 10/205,139

(22) Filed: Jul. 25, 2002

Related U.S. Application Data
(60) Provisional application No. 60/308,903, filed on Jul. 31, 2001.

(51) Int. Cl. G06F 17/60

(52) U.S. Cl. 705/38

(57) ABSTRACT

An automated method and system for analyzing a consumer's financial situation and providing tools to assist a consumer and their legal representative in filing for bankruptcy protection. The system comprises an evaluation suite and a bankruptcy filing assistance suite. The system is enabled for use over a global computer network and maintains security of personal information. Tools include attorney directory listing, financial analysis algorithms, forms generator, message handling, license purchase and assignment to clients, and case review. An attorney collaborates with a client to input financial information and generate all forms necessary for filing with a bankruptcy court.

### CROSS REFERENCE TO RELATED APPLICATION

This application is based upon and claims benefit of: copending and co-owned U.S. Provisional Patent Application Serial No. 60/308,903 entitled Automated System And Method For Consumer Financial Counseling, filed with the U.S. Patent and Trademark Office on Jul. 31, 2001, by the inventors herein, the specification of which is incorporated herein by reference.

### BACKGROUND OF THE INVENTION

1. Field of the Invention

The invention disclosed herein relates generally to providing financial advice to consumers, and more particularly to an automated method and system for analyzing a consumer's financial situation and providing tools to assist a consumer and such consumer's legal representative in filing for bankruptcy protection.

2. Background of the Prior Art

With the present growth of credit card use and increasing use of deferred payments for consumer purchases, many consumers find themselves with serious debt problems. Consumers can find themselves overwhelmed with debt and pursued by creditors and collection agencies. Many times the only viable option is personal bankruptcy.

While do-it-yourself books, software and forms libraries have emerged to capitalize on the need for low-cost self-help legal solutions, these tools typically do not sufficiently address comprehensive assessment of a financial situation. Even if such tools identify a need for filing bankruptcy, they typically do not provide tailored forms for effecting such filing, nor do they provide identification of professionals who can provide personal legal assistance in the bankruptcy process. Many such tools are geared for experienced attorneys, making them incomprehensible to the layperson; other tools, geared for the layperson, are insufficient to fully educate and advise the user.

Until now, there existed an unfulfilled need for a system comprised of on-line interactive resources for evaluating financial affairs and, if necessary, for providing forms and documents for filing bankruptcy. In addition to on-line resources to help individuals, there has also been an unfulfilled need to enable qualified attorneys to use online tools and forms to serve more clients and provide convenient filing of bankruptcy forms.

### SUMMARY OF THE INVENTION

The present invention provides a system and method for providing on-line interactive resources for evaluating financial affairs and creating bankruptcy filing forms. The system includes legal forms specifically formatted for bankruptcy courts throughout the United States. It also includes tools to maintain individual privacy while enabling access by qualified professionals.

It is an object of the instant invention to provide an automated system which enables the secure, remote exchange of information between a consumer and a financial status analysis tool, and the exchange of information between a system implementing such tool, the consumer, and the consumer's legal representative to assist in the process of filing for bankruptcy protection.

Another object of the invention is to provide a collection of forms for individuals to use for filing bankruptcy.

Another object of the invention is to provide tools for contacting an attorney to assist in filing bankruptcy.

Another object of the invention is to provide tools for direct attorney consultations.

Still another object of the invention is to provide tools for managing client account information.

In accordance with the above and other objects, an automated method and system are described for analyzing a consumer's financial situation and providing tools to assist a consumer and the consumer's legal representative in filing for bankruptcy protection. A first tool, which is remotely accessible by a consumer, provides an automated analysis of a debtor's financial situation, and stores information input by the user in a database. A second tool receives information input by the debtor using the first tool, receives information input by the debtor's legal representative, and optionally receives information input anew by the debtor himself, and processes such information to prepare bankruptcy forms suitable for filing in a formal bankruptcy proceeding.

Additional features include:

Provides a dynamic selection of court-specific requirements to generate a matrix of creditors.

Provides a client/attorney indicator system, a quick notification of concurrent online status.

Provides bankruptcy data integrity validation engine. Validates data entered in the system.

Provides a hierarchical record set of the bankruptcy case. This is an electronic standardization of court data using XML for electronic filing.

Provides an electronic signature for client and/or attorney to sign forms in appropriate places.

Integrated bankruptcy filing instructions.

Provides a preview validation interface. Documents can be previewed before closing the case.

Provides a dynamic selection of federal and state-specific exemption statutes for Schedule C with hyperlinks to most statutes available on the Internet for review.

Prepares forms in PDF and/or TXT format suitable for ECF, with ECF bankruptcy court website access and/or interface.

Provides a “Manage Clients” interface. Client files can be archived and removed from the active client list, and can be reopened and returned to list as needed.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a high-level block diagram of a system in accordance with an embodiment of the present invention;

FIG. 2 shows a consumer Introduction section of a system in accordance with an embodiment of the present invention;

FIG. 3 shows a consumer Welcome section of a system in accordance with an embodiment of the present invention;

FIG. 4 shows an Evaluator start page of a system in accordance with an embodiment of the present invention;

FIG. 5 shows a disclaimer page of a system in accordance with an embodiment of the present invention;

FIG. 6 shows a first financial input page of a system in accordance with an embodiment of the present invention;

FIG. 7 shows a second financial input page of a system in accordance with an embodiment of the present invention;

FIG. 8 shows a third financial input page of a system in accordance with an embodiment of the present invention;

FIG. 9 shows a fourth financial input page of a system in accordance with an embodiment of the present invention;

FIG. 10 shows a fifth financial input page of a system in accordance with an embodiment of the present invention;

FIG. 11 shows a sixth financial input page of a system in accordance with an embodiment of the present invention;

FIG. 12 shows a seventh financial input page of a system in accordance with an embodiment of the present invention;

FIG. 13 shows an eighth financial input page of a system in accordance with an embodiment of the present invention;

FIG. 14 shows a first possible findings page of a system in accordance with an embodiment of the present invention;

FIG. 15 shows a second possible findings page of a system in accordance with an embodiment of the present invention;

FIG. 16 shows a third possible findings page of a system in accordance with an embodiment of the present invention;

FIG. 17 shows a flowchart for carrying out steps for access by a subscription user of a system in accordance with an embodiment of the present invention;

FIG. 18 shows a new account creation page of a system in accordance with an embodiment of the present invention;

FIG. 19 shows a personal welcome page of a system in accordance with an embodiment of the present invention;

FIG. 20 shows a user login page of a system in accordance with an embodiment of the present invention;

FIG. 21 shows a personal information page of a system in accordance with an embodiment of the present invention;

FIG. 22 shows a flowchart for data entry in accordance with an embodiment of the present invention;

FIG. 23 shows a first income and expenses input page of a system in accordance with an embodiment of the present invention;

FIG. 24 shows a second income and expenses input page of a system in accordance with an embodiment of the present invention;

FIG. 25 shows a third income and expenses input page of a system in accordance with an embodiment of the present invention;

FIG. 26 shows a fourth income and expenses input page of a system in accordance with an embodiment of the present invention;

FIG. 27 shows a fifth income and expenses input page of a system in accordance with an embodiment of the present invention;

FIG. 28 shows a sixth income and expenses input page of a system in accordance with an embodiment of the present invention;

FIG. 29 shows a seventh income and expenses input page of a system in accordance with an embodiment of the present invention;

FIG. 30 shows an eighth income and expenses input page of a system in accordance with an embodiment of the present invention;

FIG. 31 shows a ninth income and expenses input page of a system in accordance with an embodiment of the present invention;

FIG. 32 shows an assets definition page of a system in accordance with an embodiment of the present invention;

FIG. 33 shows a first assets input page of a system in accordance with an embodiment of the present invention;

FIG. 34 shows a second assets input page of a system in accordance with an embodiment of the present invention;

FIG. 35 shows a personal property index page of a system in accordance with an embodiment of the present invention;

FIG. 36 shows a first personal property assets input page of a system in accordance with an embodiment of the present invention;

FIG. 37 shows a second personal property assets input page of a system in accordance with an embodiment of the present invention;

FIG. 38 shows a liabilities definition page of a system in accordance with an embodiment of the present invention;

FIG. 39 shows a secured claims liability page of a system in accordance with an embodiment of the present invention;

FIG. 40 shows a first example of a priority claims liability input page of a system in accordance with an embodiment of the present invention;

FIG. 41 shows a second example of a priority claims liability input page of a system in accordance with an embodiment of the present invention;

FIG. 42 shows a third example of a priority claims liability input page of a system in accordance with an embodiment of the present invention;

FIG. 43 shows a fourth example of a priority claims liability input page of a system in accordance with an embodiment of the present invention;

FIG. 44 shows a portion of a financial analysis output page of a system in accordance with an embodiment of the present invention;

FIG. 45 shows a high-level block diagram for operation of a system in accordance with an embodiment of the present invention;

FIG. 46 shows an attorney Introduction section of a system in accordance with an embodiment of the present invention;

FIG. 47 shows an attorney directory information page of a system in accordance with an embodiment of the present invention;

FIG. 48 shows an attorney directory start page of a system in accordance with an embodiment of the present invention;

FIG. 49 shows a first attorney directory log-in page of a system in accordance with an embodiment of the present invention;

FIG. 50 shows a second attorney directory log-in page of a system in accordance with an embodiment of the present invention;

FIG. 51 shows attorney directory listing options of a system in accordance with an embodiment of the present invention;

FIG. 52 shows a first attorney directory data input page of a system in accordance with an embodiment of the present invention;

FIG. 53 shows a second attorney directory data input page of a system in accordance with an embodiment of the present invention;

FIG. 54 shows a third attorney directory data input page of a system in accordance with an embodiment of the present invention;

FIG. 55 shows a connection speed preference page of a system in accordance with an embodiment of the present invention;

FIG. 56 shows an attorney sign up page of a system in accordance with an embodiment of the present invention;

FIG. 57 shows a registered user login page of a system in accordance with an embodiment of the present invention;

FIG. 58 shows an attorney user welcome page of a system in accordance with an embodiment of the present invention;

FIG. 59 shows a license assignment page of a system in accordance with an embodiment of the present invention;

FIG. 60 shows a client login page of a system in accordance with an embodiment of the present invention;

FIG. 61 shows a client data input page of a system in accordance with an embodiment of the present invention;

FIG. 62 shows a client user welcome page of a system in accordance with an embodiment of the present invention;

FIG. 63 shows a message center page of a system in accordance with an embodiment of the present invention;

FIG. 64 shows a partial on-line help guide page of a system in accordance with an embodiment of the present invention;

FIG. 65 shows a flowchart for system action when interacting with an attorney in accordance with an embodiment of the present invention;

FIG. 66 shows a flowchart illustrating system actions pursuant to form selection instructions in accordance with an embodiment of the present invention;

FIG. 67 shows a flow chart illustrating system actions pursuant to case review selection instructions in accordance with an embodiment of the present invention;

FIG. 68 shows a first typical analysis output page in accordance with an embodiment of the present invention;

FIGS. 69a & 69b show a second typical analysis output page in accordance with an embodiment of the present invention; and

FIGS. 70a & 70b show a third typical analysis output page in accordance with an embodiment of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The term user, as employed herein, means an individual utilizing the system of the subject invention to analyze financial affairs. The term subscriber, as employed herein, means a user who may access templates and forms, and store data on the system. The term template, as employed herein, refers to any means for providing information, including predefined forms having blank spaces for completion by a user.

The system of the present invention is implemented for on-line user access over a computer network, preferably the Internet and particularly the World Wide Web, using prevailing Internet access and browser software, such as Microsoft's Windows operating system and either Netscape Navigator or Microsoft's Internet Explorer browser. The system may also be implemented on local area networks, wide area networks, intranets and computers providing direct dial-up access to users. The system may include HTML, scripts (e.g., JAVA and VB), cgi applications, activeX data objects, applets, database software, databases and the like.

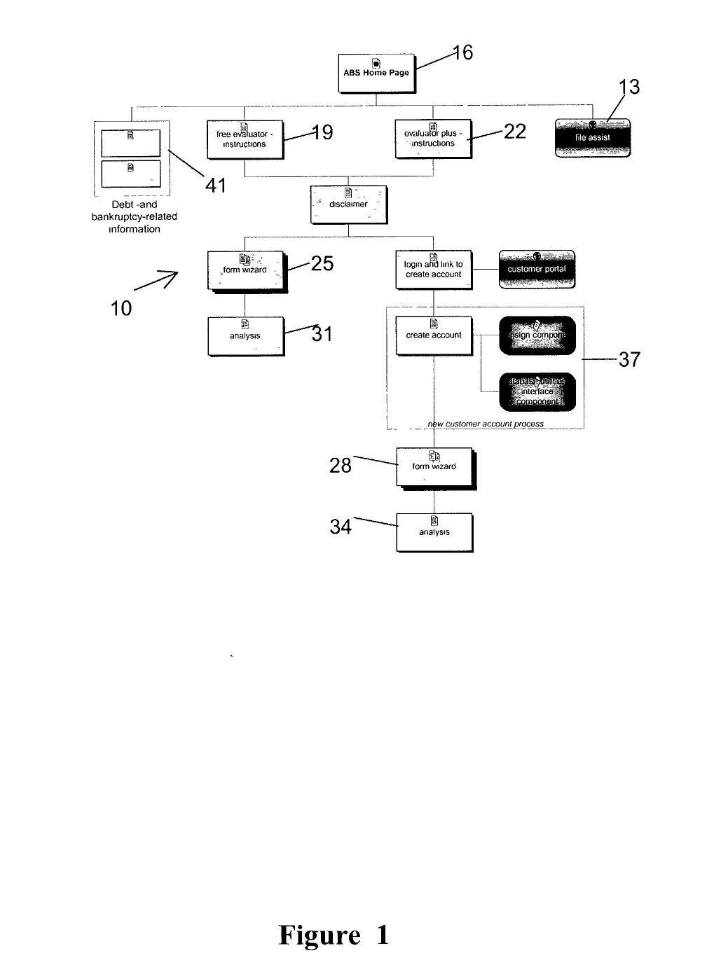

A method and system are provided for analyzing a consumer's financial situation and providing tools to assist a consumer and the consumer's legal representative in filing for bankruptcy protection. A schematic representation of the system is shown in FIG. 1. The system comprises a first “evaluation” suite shown generally at 10 (referred to at times herein as “Evaluator”) and a second “bankruptcy filing assistance” suite 13 (referred to at times herein as “FileAssist ASP”).

Preferably, the system is divided into discrete intuitive sections to facilitate administration as well as user navigation. For example, a user may first access the system through a “Home” page 16. A new user may initially access the free Evaluator analysis tool 19. Alternatively and additionally, a user may access the Evaluator PLUS tool 22 that provides financial analysis and stores input data for further use in bankruptcy filing.

The evaluation suite 10 comprises a detailed cash flow analyzer which collects a consumer's financial data (e.g., income, expenses, etc.) using templates enabled by form wizard 25 or 28, processes that data, outputs an analysis 31, 34 of the user's financial condition, and advises the consumer of what steps to take with respect to their debt management. This application provides the user with tools 37 to create an account and pay electronically with a major credit card. After a valid form of payment has been verified, the application will create a database record 41 for the user.

The evaluation suite 10 produces both a preliminary and an in-depth analysis of the financial situation of the user. The preliminary analysis is contained in 31, and 34 contains general information and options based on data entered, as well as specific analysis in a Chapter 13 worksheet form. The evaluation suite does not produce court-filing documents.

The bankruptcy filing assistance suite 13 comprises a service designed to benefit both attorneys and their clients by using the Internet to provide methods to collaborate and complete information necessary for bankruptcy forms. Bankruptcy filing assistance suite 13 compiles financial data entered by the user and attorney, and generates necessary bankruptcy forms needed to file for bankruptcy under Chapter 7 and Chapter 13.

The tools are organized in a hierarchy of pages with links to appropriate templates and information to facilitate user navigation. At each level of the hierarchy, the system preferably provides written information and may request data from the user.

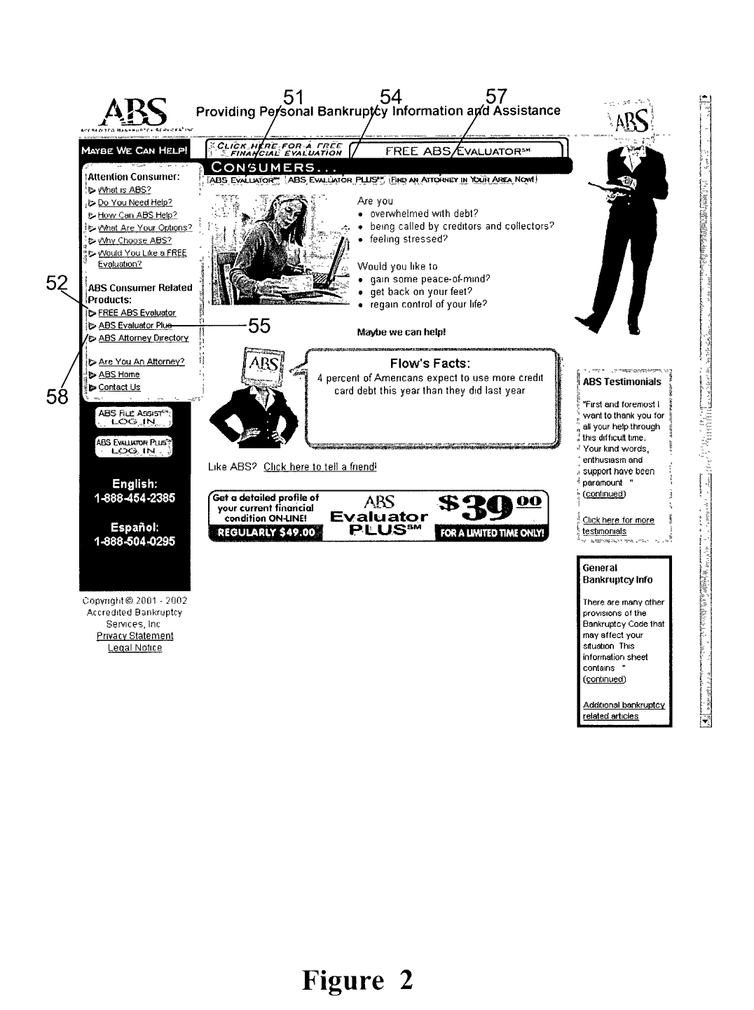

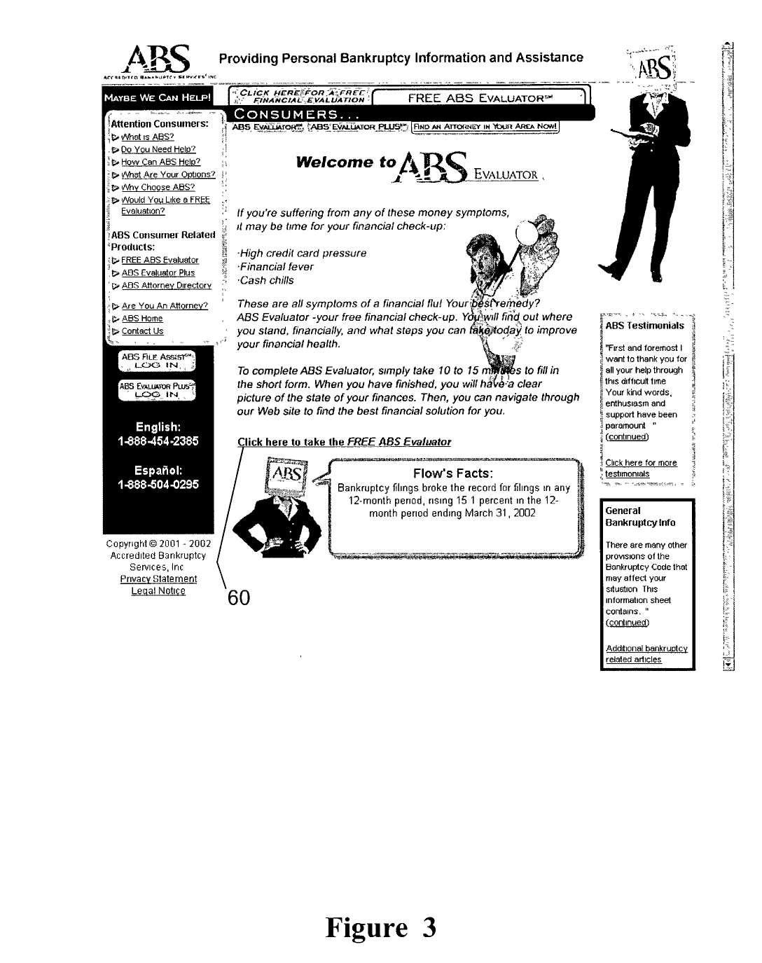

Consumer users may link to information such as indicated on FIG. 2. By selecting the Evaluator tab 51 at the top of FIG. 2, or the Evaluator link 52 the user is directed to a Welcome screen for the free Evaluator, FIG. 3. Alternatively, a user can select the Evaluator PLUS tab or the Evaluator PLUS link 55. (Evaluator PLUS is a fee-based feature of the invention.) To find an attorney for professional legal assistance, the user can select the Find an Attorney tab 57 or the Attorney Directory link 58.

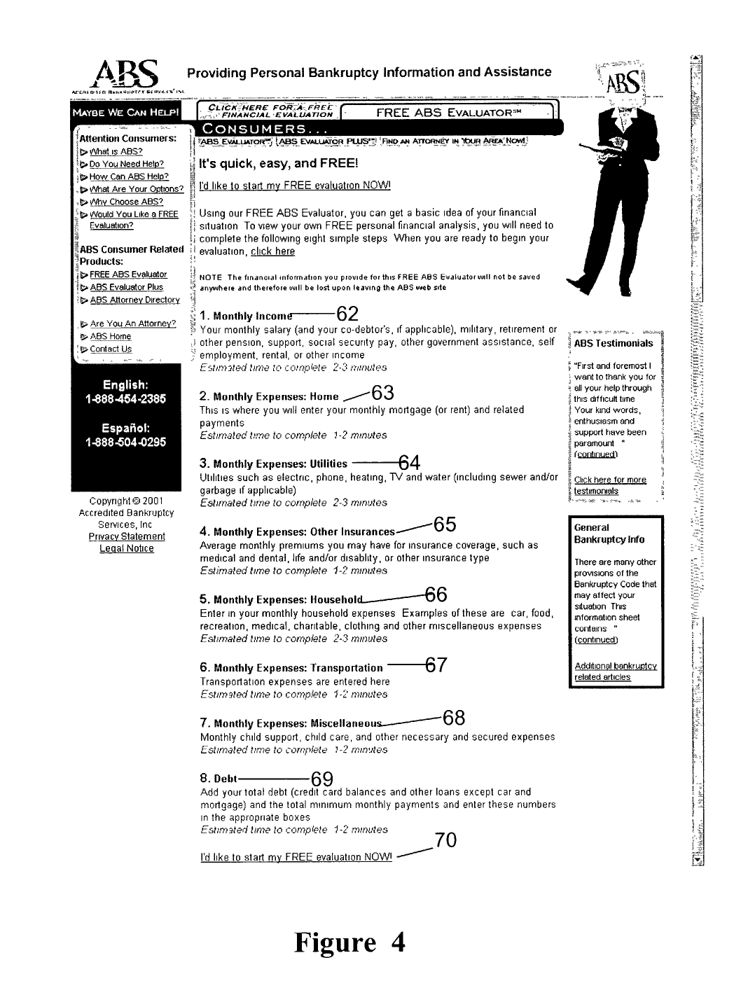

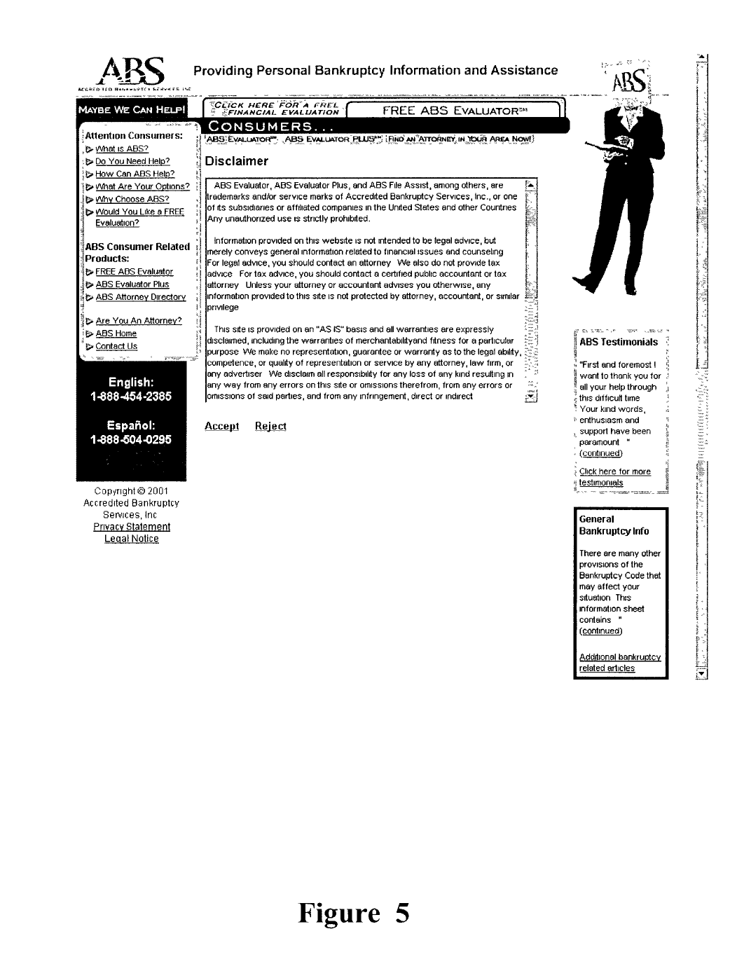

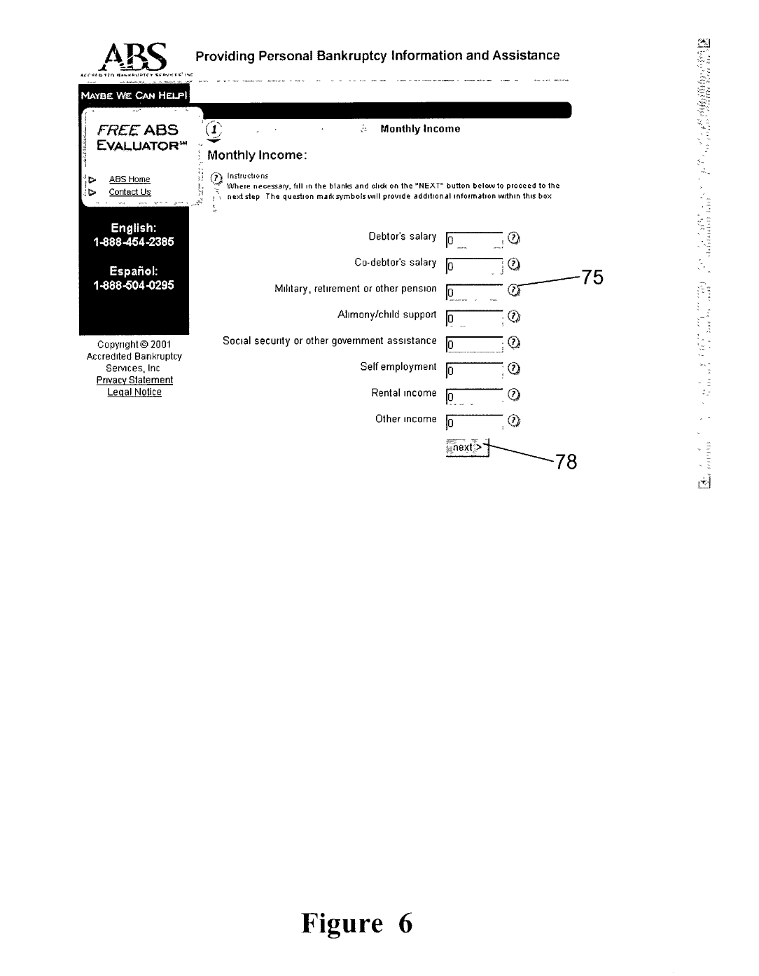

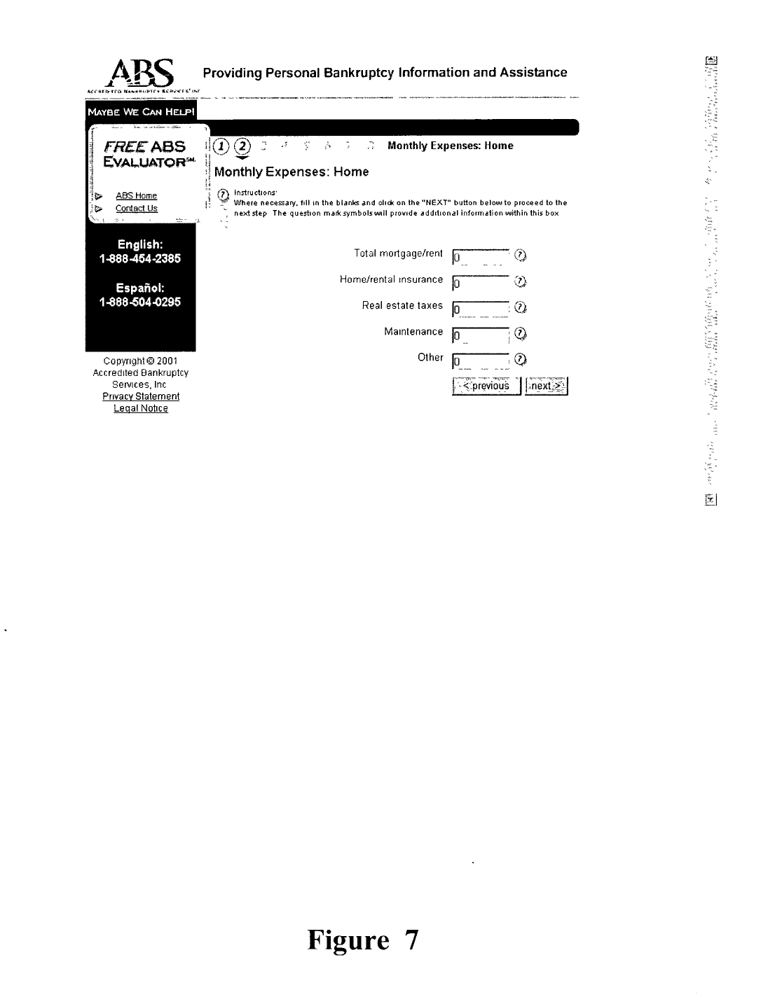

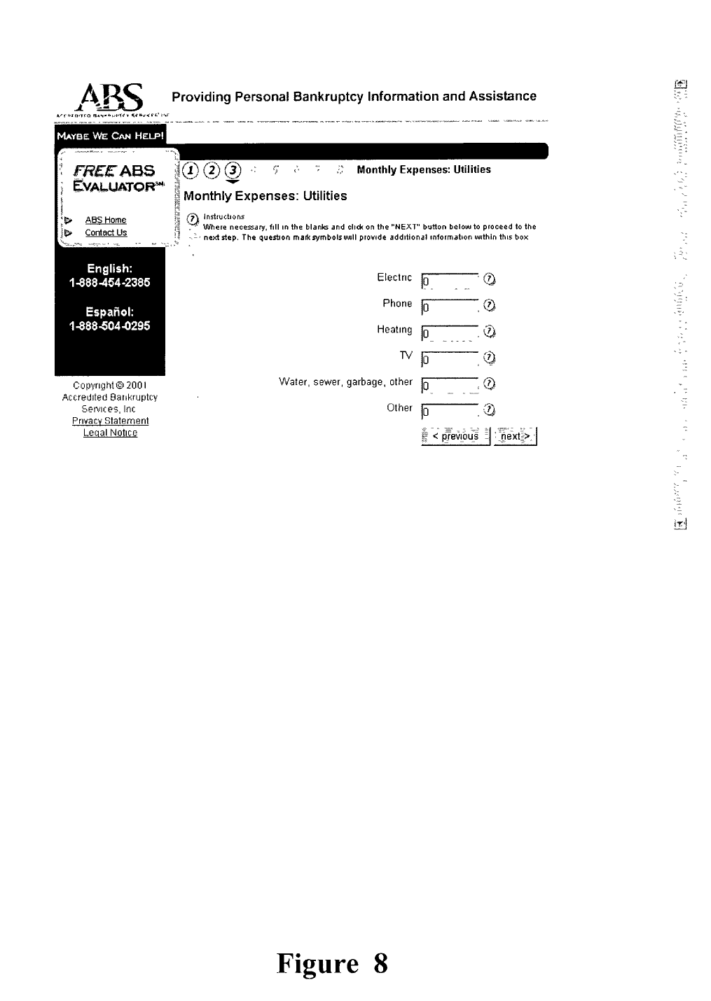

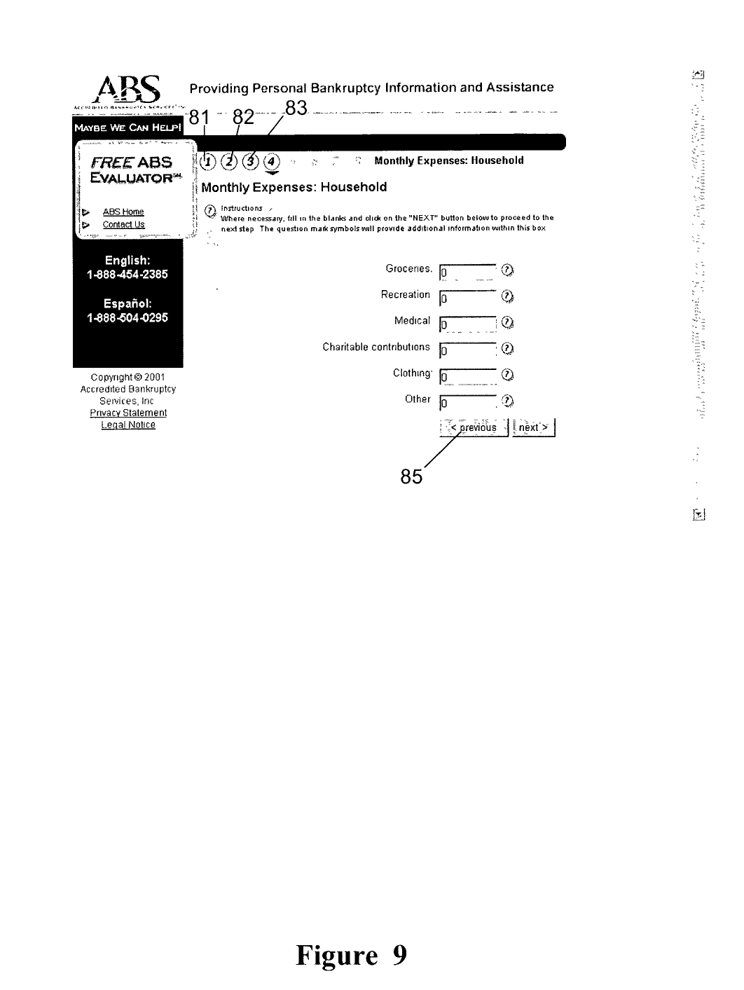

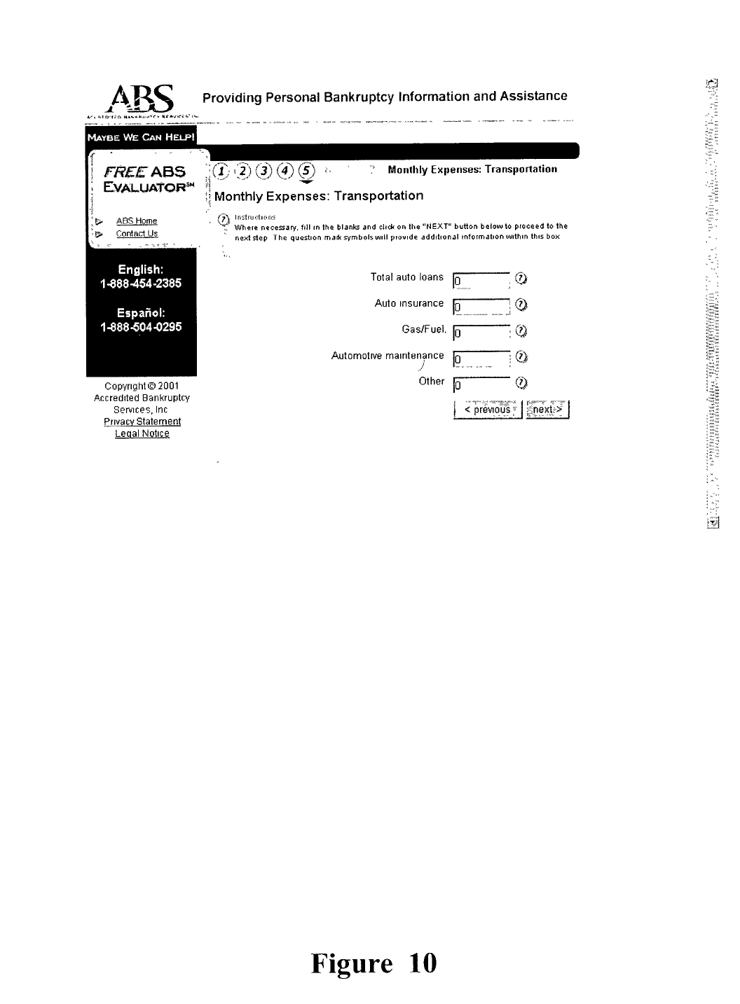

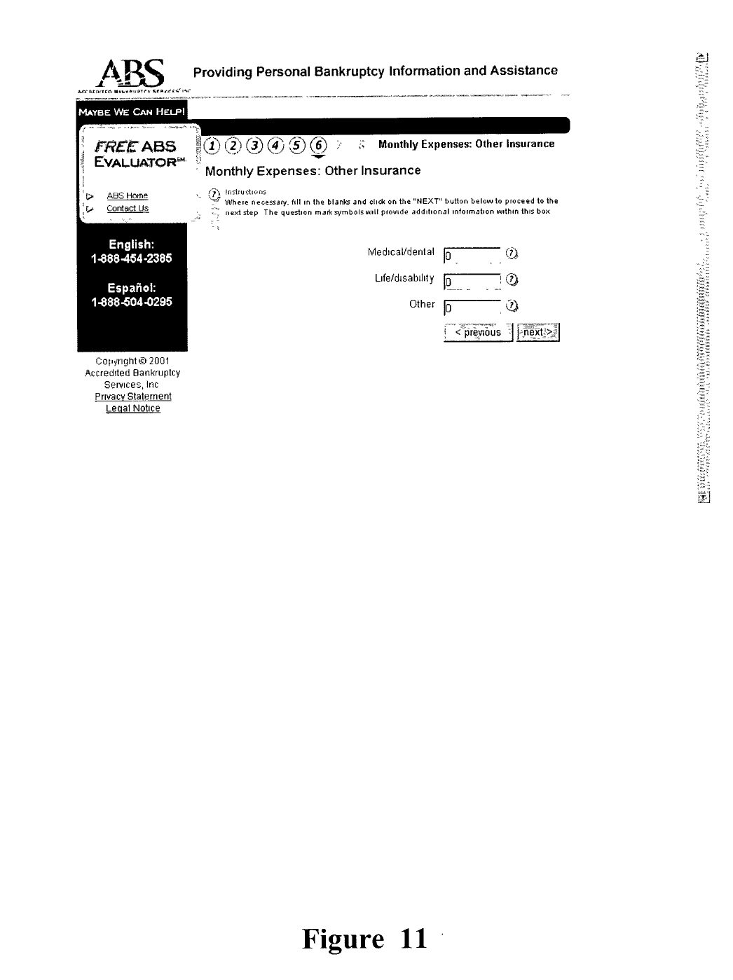

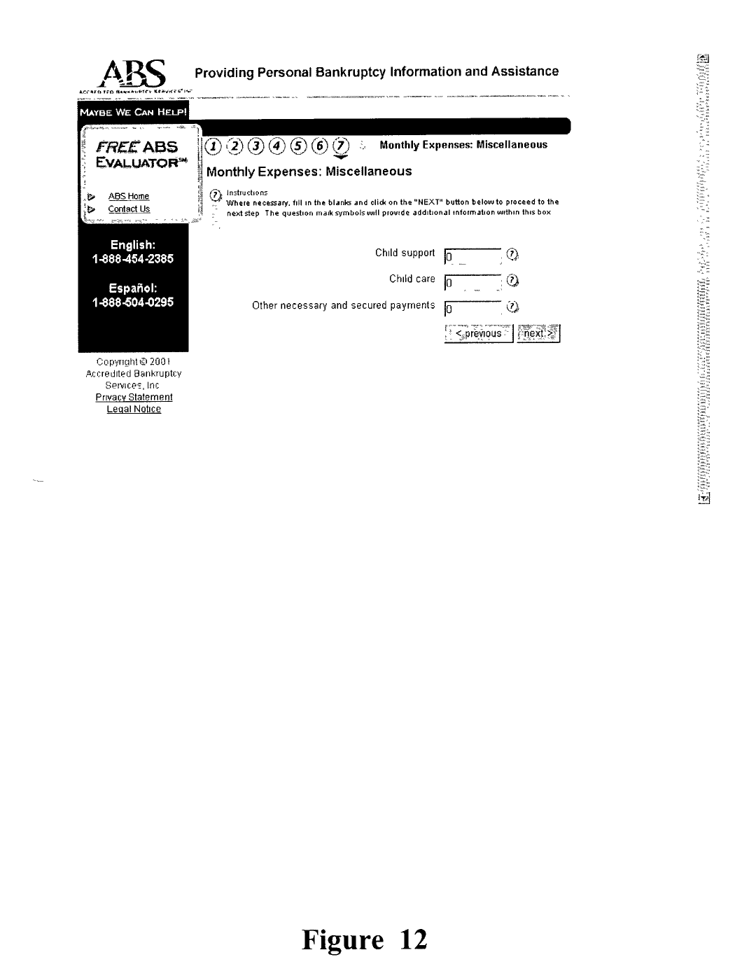

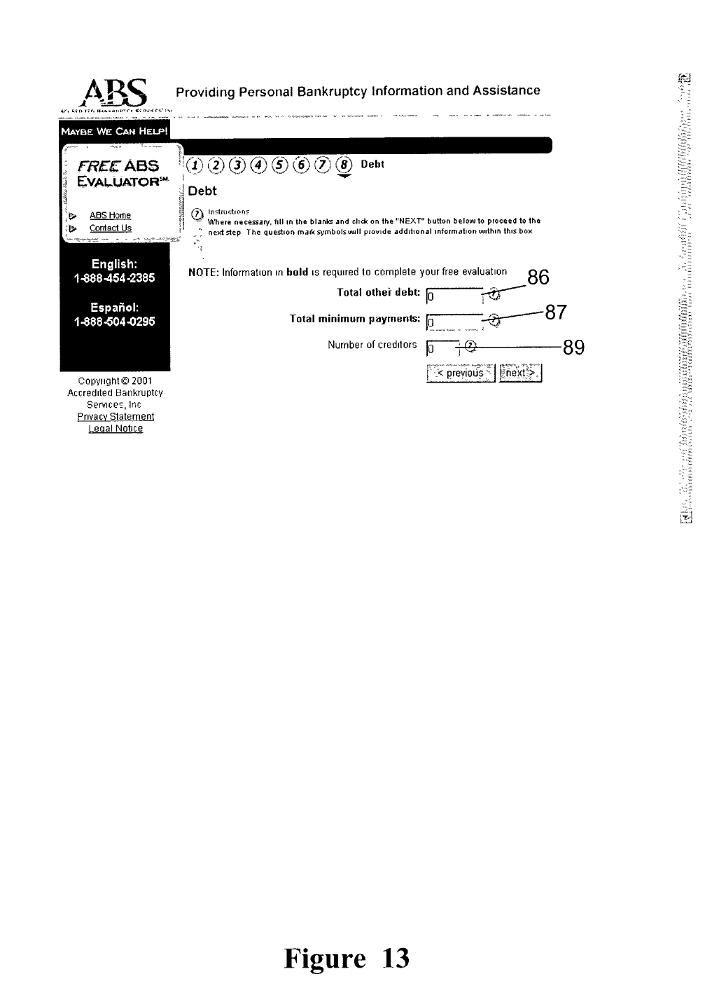

Referring to FIG. 3, a short Welcome screen is displayed with a link 60 to the Evaluator tool. By selecting the Evaluator tool link 60, the user is directed to an information page. FIG. 4 briefly describes the eight steps required to input personal financial information and indicates the types of information required for each step, with an estimate of the amount of time required for completing each step. Follow-on links are used to gather financial information. Referring to FIG. 4, financial information such as monthly income 62 (see FIG. 6), monthly home expenses 63 (see FIG. 7), monthly utility expenses 64 (see FIG. 8), monthly insurance expenses 65 (see FIG. 9), monthly household expenses 66 (see FIG. 10), monthly transportation expenses 67 (see FIG. 11), miscellaneous monthly expenses 68 (see FIG. 12), and total debt 69 (see FIG. 13) information is requested for input. Of course, such categories of financial information are exemplary only, and additional or fewer categories may be provided without departing from the spirit and scope of the instant invention. Hyperlink 70 directs the user to a disclaimer page (FIG. 5) and then to data entry pages such as illustrated in FIGS. 6-13. For example, FIG. 6 shows a template for entering financial information concerning Monthly Income. Such financial information may include Debtor's salary, Co-debtor's salary (if any), Pension income, Alimony/child support, Social security or other government assistance, Self-employment income, Rental income, and any Other income. For help, the user may select any of the question mark buttons, such as 75 for an explanation of the categories of data to input in the template windows. The user is directed to subsequent templates, in order, by selecting the ‘next’ button 78.

Referring now to FIG. 9, after each template is completed, the corresponding template number is highlighted, such as templates 1, 2, and 3, elements 81, 82, 83, respectively. The user can backup to any previously completed template by clicking on the appropriate template number. Any of the requested information can be added, deleted or modified. The user can return to the immediately preceding template by selecting the ‘previous’ button 85.

FIG. 13 illustrates the template for inputting consumer debt. Debt is the total amount owed to creditors and is distinguished from monthly expenses. Total debt is input to window 86 and the monthly payment to creditors is input to window 87, with the total number of creditors input to window 89.

Once the user has input income, expense and debt data, the system calculates disposable income and a ratio of disposable income to total debt.

Disposable income=income−expenses

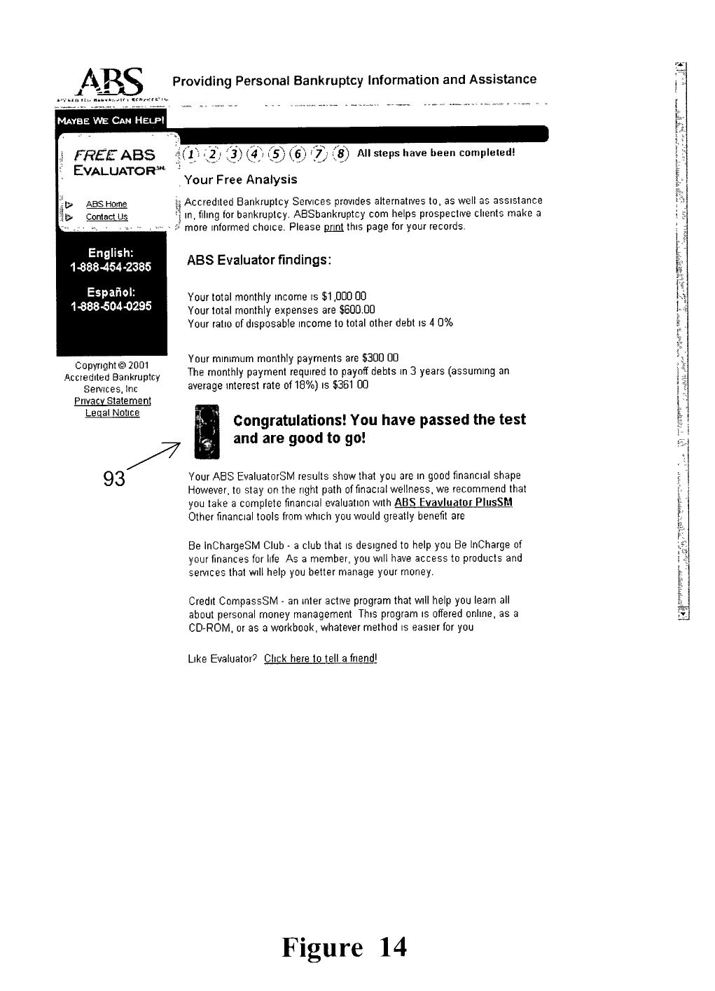

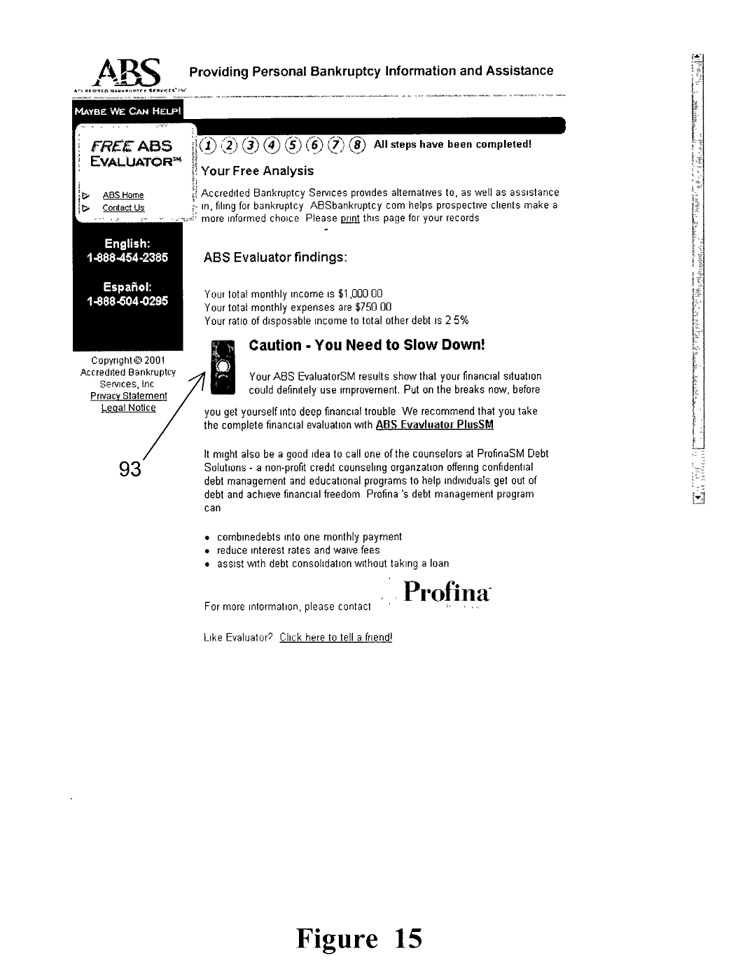

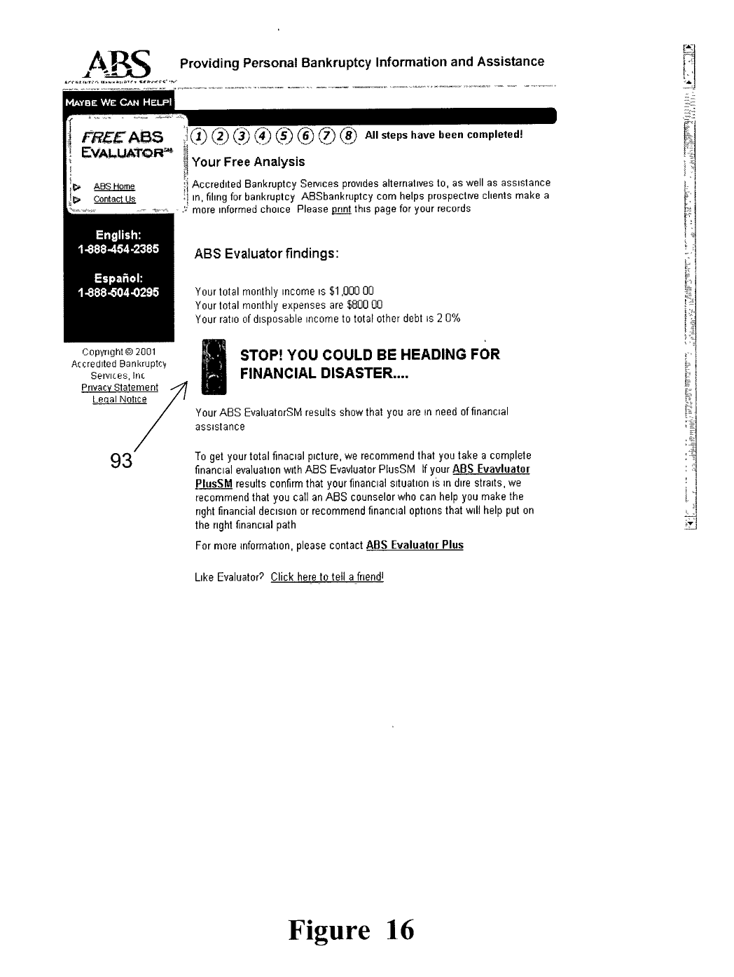

Based on the ratio of disposable income to total debt, the system provides a high level, relative determination of financial well being. Examples of the results of the initial evaluator are graphically depicted using a stoplight rubric 93 shown in FIGS. 14-16. For example, FIG. 14 shows a “green” light and presents findings that the user's financial condition appears to be “good to go”. FIG. 15 shows a “yellow” light and presents findings that the user's financial condition could use improvement. The user needs to slow down and may be a good candidate for a Debt Management Program. Enrollment in a non-profit credit counseling/debt management program might be appropriate, whereby trained professionals work with creditors on behalf of the debtor to secure cost-saving benefits. FIG. 16 shows a “red” light and presents findings that the user's financial condition appears to be heading for financial disaster, and may be beyond the point where credit counseling/debt management can help. Other options available by the present invention can provide the user with more information to make an informed decision.

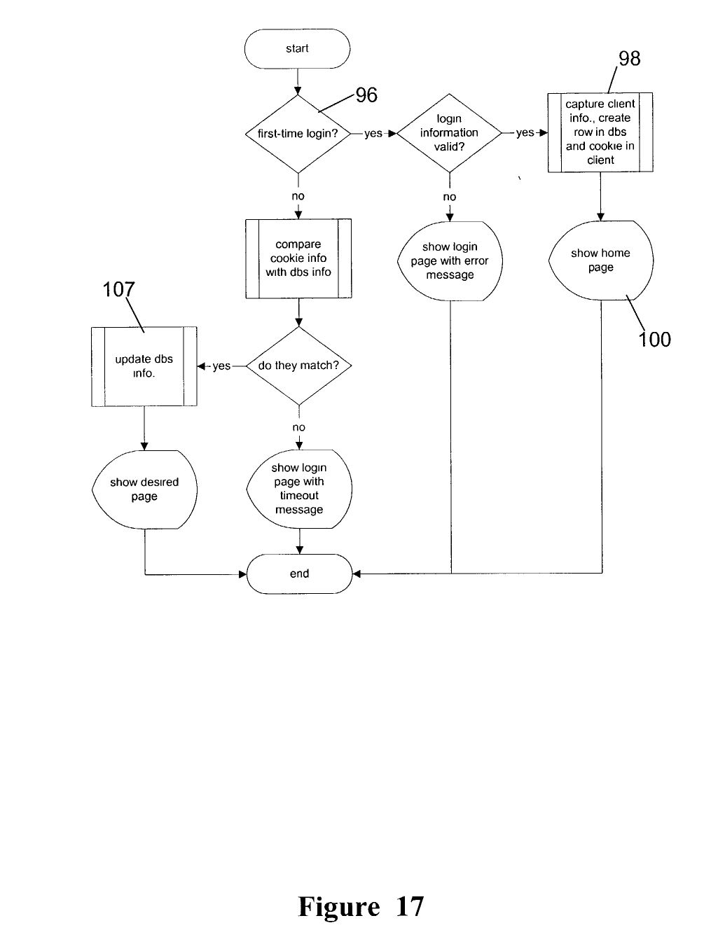

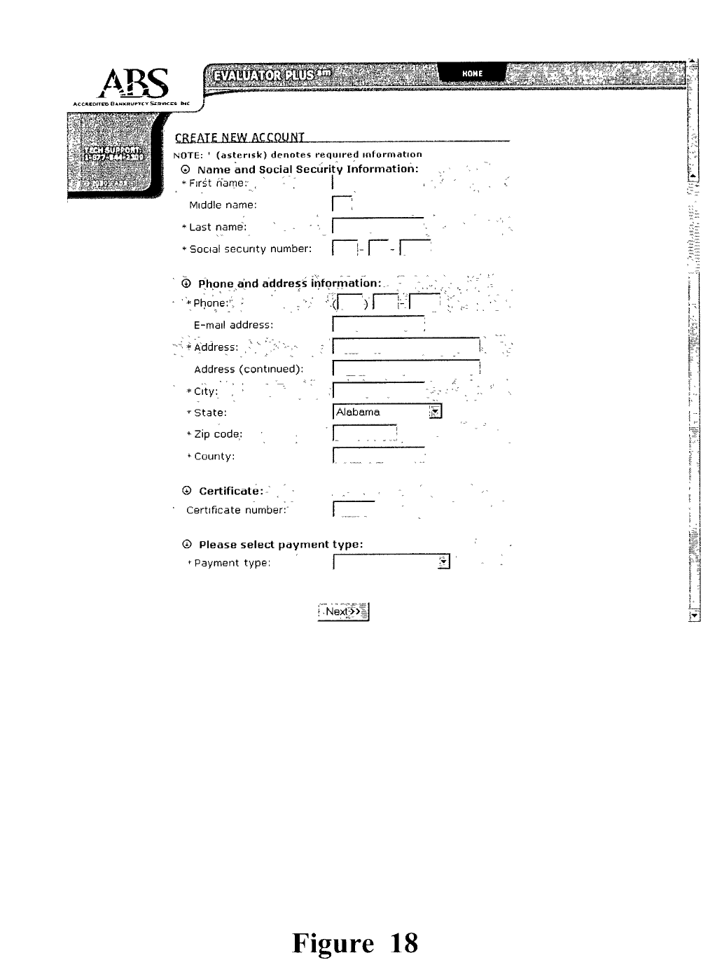

An additional feature of the present invention is referred to as Evaluator PLUS, which is a fee-based tool that gathers additional information concerning financial status to perform a highly detailed analysis of a user's financial condition. FIG. 17 schematically depicts a system for a user to log into the subject system. The first step in using Evaluator PLUS is to create an account. The first time a user logs in at step 96, the system captures personal identification data. FIG. 18 illustrates an exemplary page for creating a new account. Information input to Evaluator PLUS is stored in a database and can be used by the same client in the bankruptcy filing assistance suite, another feature of the present invention.

When a user account is created, a unique identifier (identity) is also created automatically 98. Such unique identifier is stored in both the system database and in the user's computer as a “cookie”. A “cookie” is a widely known industry standard object in Internet technology. It is a small piece of data that is written to the user's browser that is then accessible when the user is visiting your particular website. The “cookie” also will save the user's original IP address for extra security measures. Because the information is highly personal and confidential, the HTTPS protocol should be used when sending information back and forth to a user.

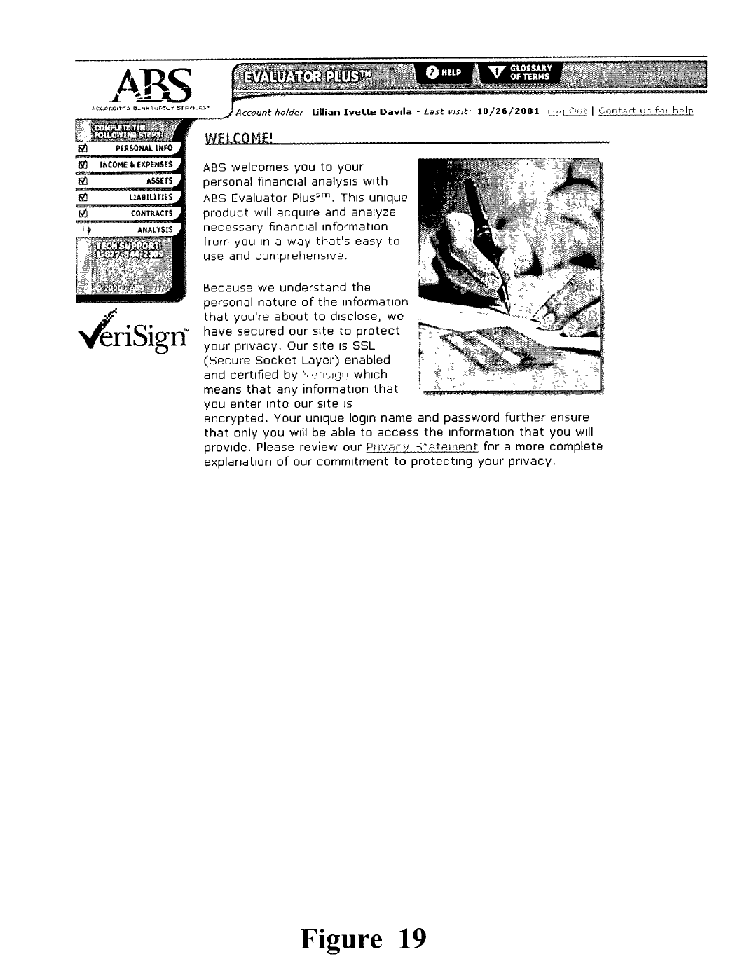

Once initial data has been entered, the user is directed to a home page “Welcome” screen 100, such as FIG. 19.

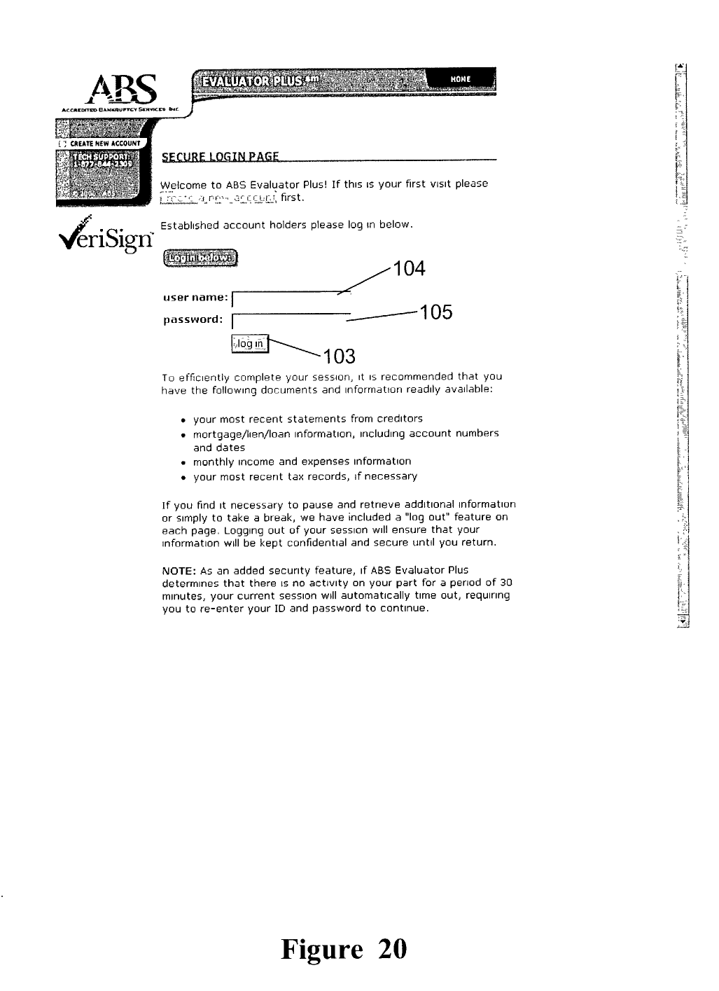

Users that have an established account can login by selecting the ‘log in’ link 103 (FIG. 20). A valid user can enter a unique ‘user name’ 104 and personal ‘password’ 105. Such user login facilitates rapid, secure access to user personal information.

The user name and password are stored in the system database. When a user logs onto the system, such user enters a unique user name and personal password. The user name and password are verified against a database of authorized users. If the user name and password match, the system generates a unique “dialogue id” for that user, for the current session. The “dialogue id” is a unique number stored in the system database 107 (FIG. 17). The “dialogue id” is also written back to the user's computer into a ““cookie”.” Once the unique “dialogue id” is written back to the user's computer in a “cookie”, the user can move freely through the system.

Every time a user moves from one screen to another, the user's “cookie” is checked for the “dialogue id”. If no “dialogue id” is found, the user is logged out of the application. This security measure prevents an unauthorized user from trying to access the system from other than the login screen without first logging in and allowing a “dialogue id” cookie to be created on their computer. If a “dialogue id” is found on the user's computer, it is verified in the system database.

A State Record is a record in the system database that holds the particular “dialogue id” mentioned above. Every time a user requests a new screen, the State Record is verified. Use of a State Record is an efficient method for verifying that each user is a valid user who has recently logged into the system and has been assigned a unique “dialogue id”. Such use of a State Record provides both a security mechanism and a state management mechanism. By comparing the contents of the user's “cookie”, which should include a “dialog id” and original IP address, with the record created for the user's state in each page assures that the appropriate person is viewing client information.

The user's State Record in the database also keeps track of the start time and date of the visit and calculates any period of inactivity. The default time for a user's session is 30 minutes. If the user is inactive for 30 minutes and then attempts to access a page within the application, the system will require the user to login again. After the user successfully logs in, access to the system is allowed again and the user can access the desired page. Thus, when the user's “cookie” is checked for the “dialogue id”, if the last time such “dialogue id” was verified is more than 30 minutes old, the user is logged out of the application and required to log back in to continue to use the system. Such automatic termination after 30 minutes protects against unauthorized users gaining inadvertent access to the system due to failure of an authorized user to log out.

If the “dialogue id” is less than 30 minutes old, then the user is granted access to the requested page, which is sent to the user's browser for display. In essence, a user's “dialogue id” times out after 30 minutes of non-activity, or immediately when a user chooses to log out of the system. A user then cannot get back into the system until the user logs back into the system by entering their user name and password and a new “dialogue id” is generated and is placed on that user's computer in a “cookie”.

Thus, User State is preserved by comparing the contents of the “cookie” and the record created for a particular user session in each page in the application. User State is closely related to the “dialogue id” system described above and is part of the security mechanism for verifying that a user is a valid user who has recently logged into the system and has been assigned a unique “dialogue id” for that particular session. The User State is also a method of keeping track of information for that particular user (such as that user's client id) as the user navigates through the system, without needing to store repetitive information on the client's computer. Storing internal information, such as client id, social security number, etc. on the client's computer is considered a security risk and is not done in the system of the instant invention. When a user moves from one screen to another, that particular user's account information usually needs to be retrieved from the system database to populate appropriate templates with the user's information. Such information usually needs to be accessed using a particular id (such as client id for example). However, a client id is not sent to the system database from the client's computer when a new page is requested. Only the “dialogue id” is stored on the client's computer for security reasons and only the “dialogue id” is sent to the system database when a new page is requested.

In order to be able to access a user's client id (or other appropriate information) whenever a user requests a particular screen, the client id must be stored with the “dialogue id” in the database when the “dialogue id” is created, which, in turn is when the user logs in. Then, whenever the client requests a new page, the “dialogue id” is retrieved from the user's request and checked for validation. If the “dialogue id” is valid, the client id (and other information) is now available to the system to retrieve that client's information for display.

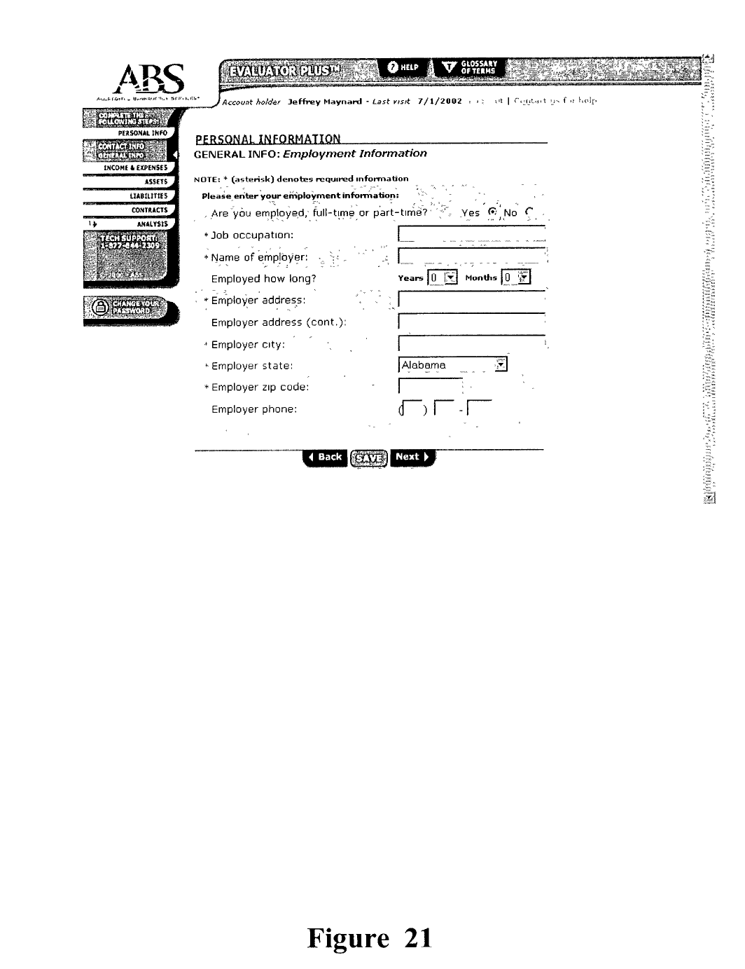

The system of the instant invention is designed to present a number of different templates to a user to collect information. Clients and attorneys enter information using such templates. For example, after a user account has been created, the user may be requested to input additional, general personal data, such as information concerning employment using a template such as shown in FIG. 21. When a template is submitted, the data goes through a verification process that is different for each template. If the verification is successful, the data is saved to a database.

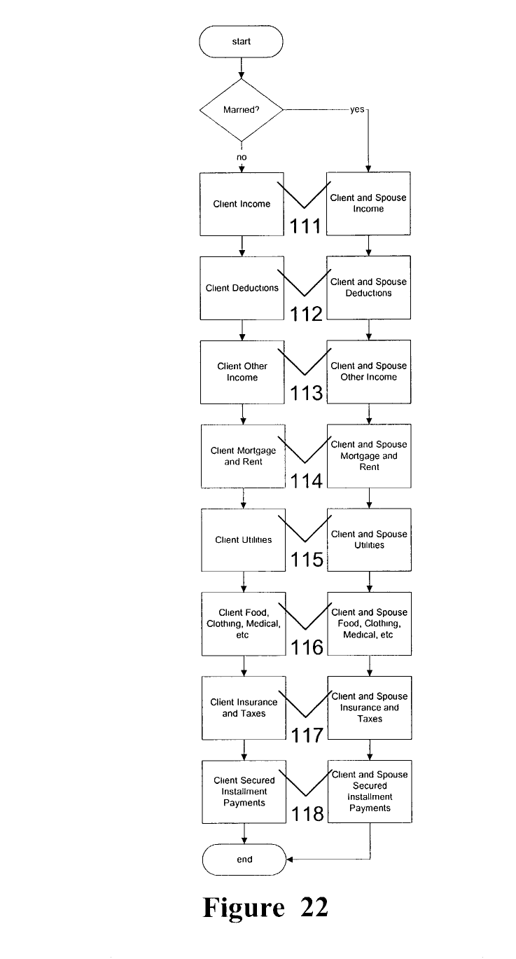

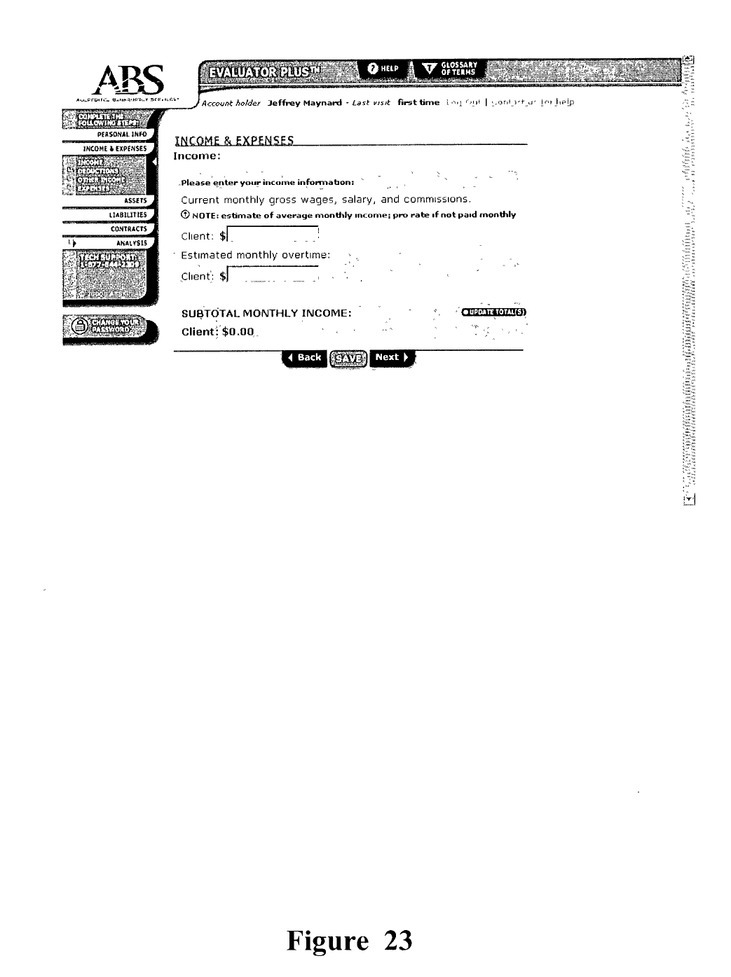

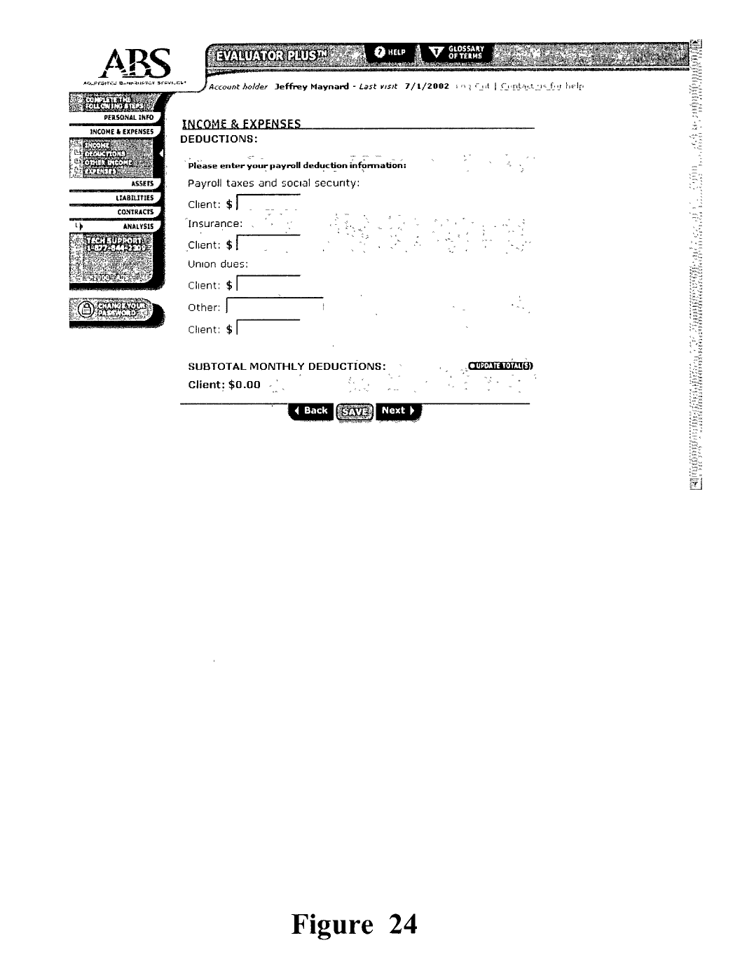

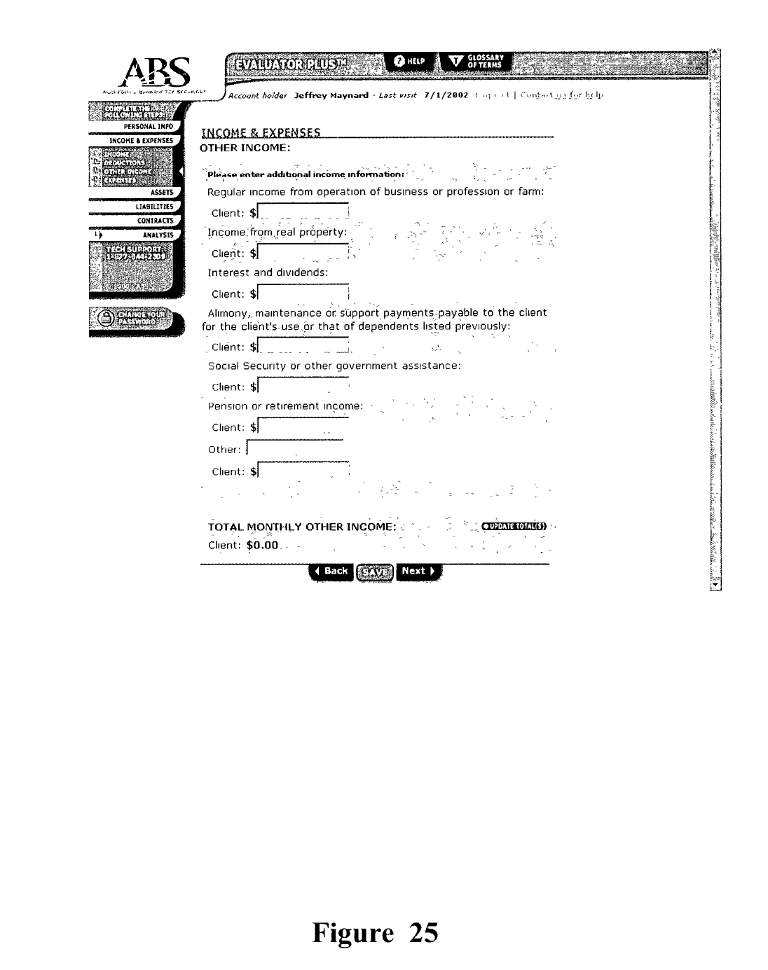

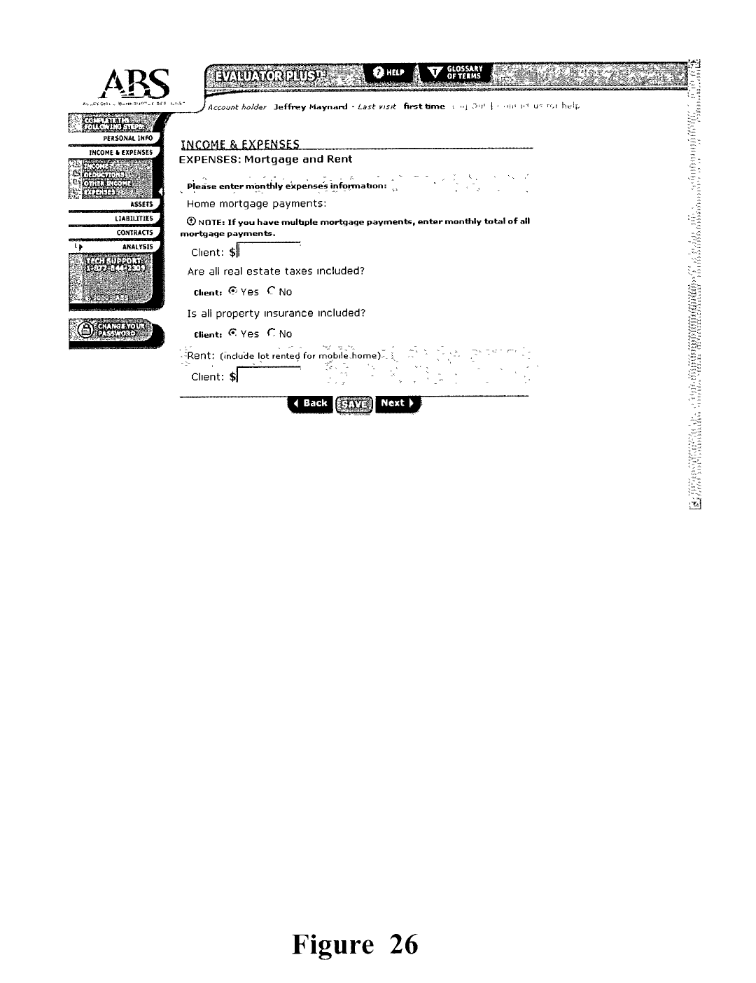

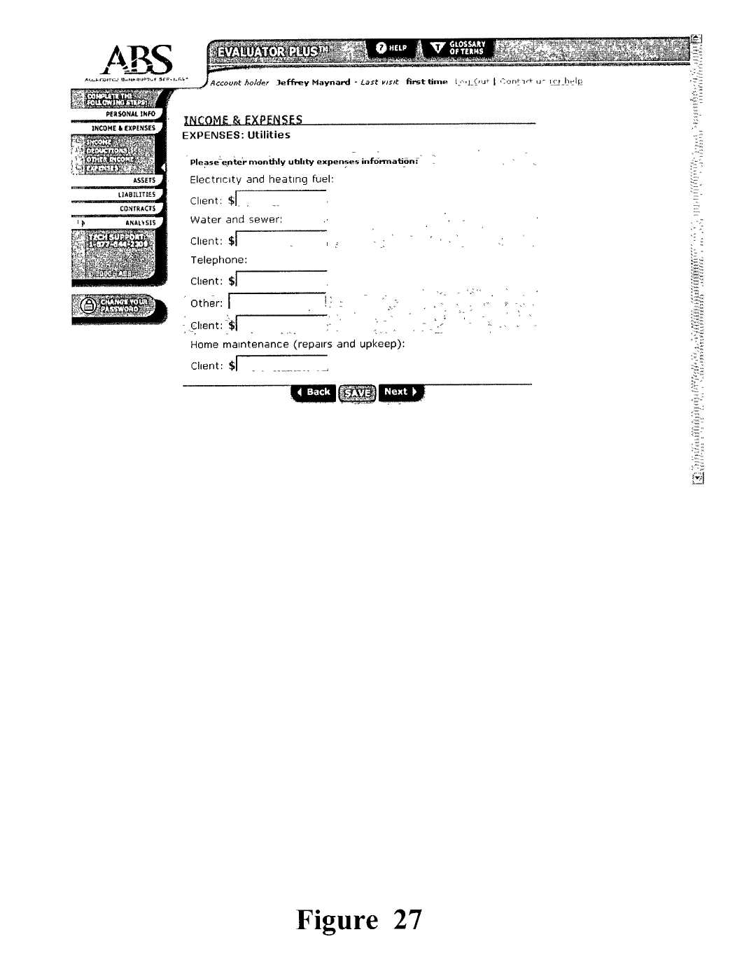

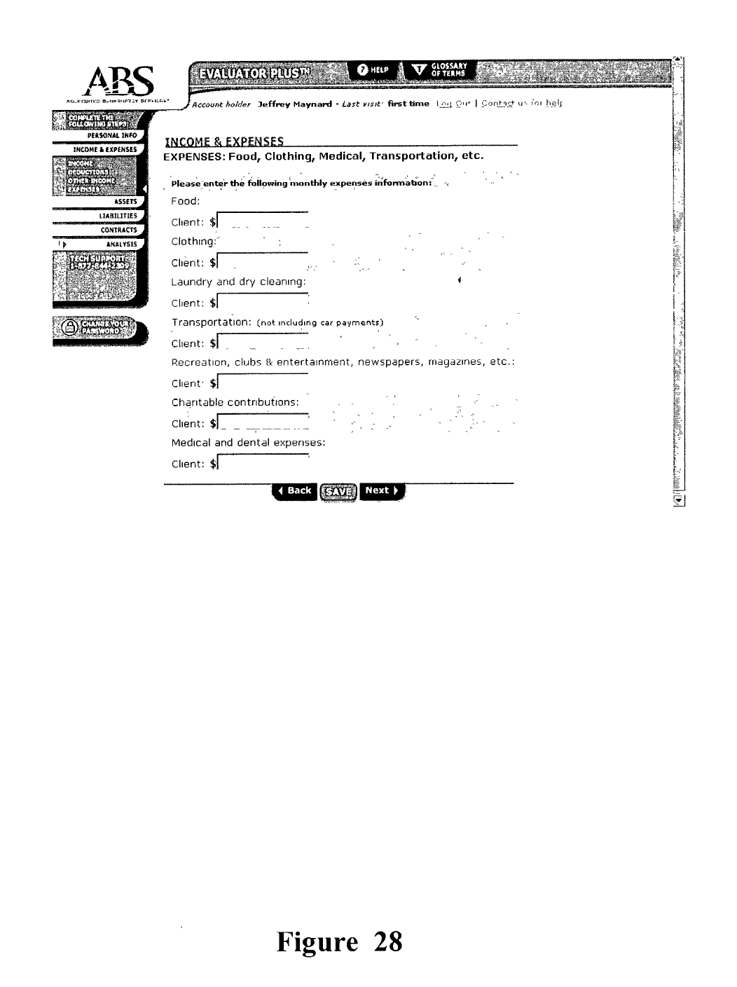

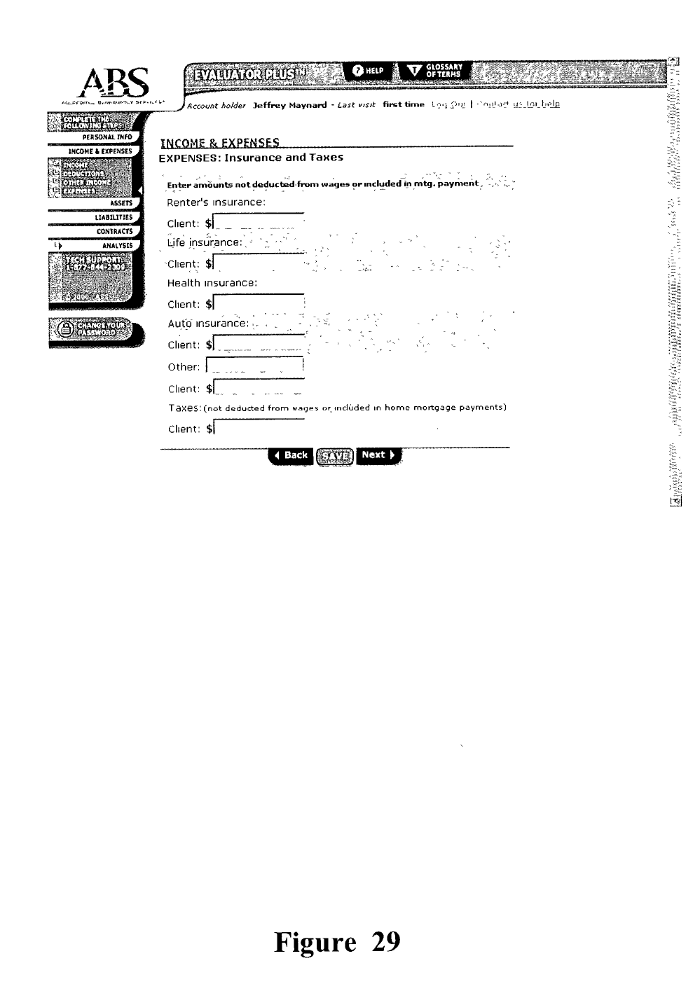

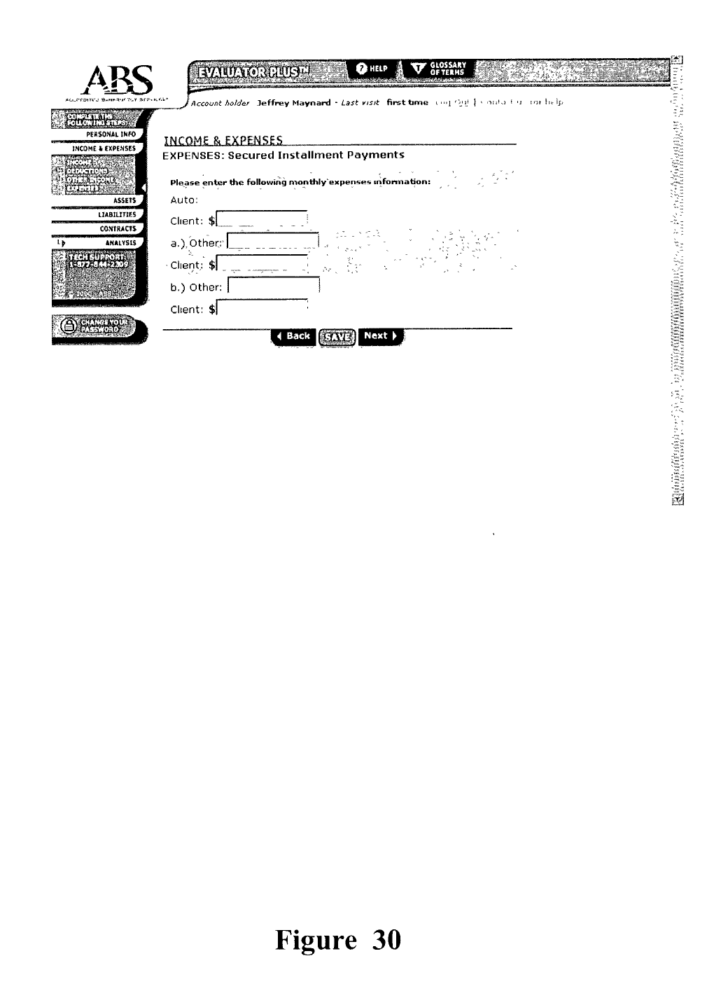

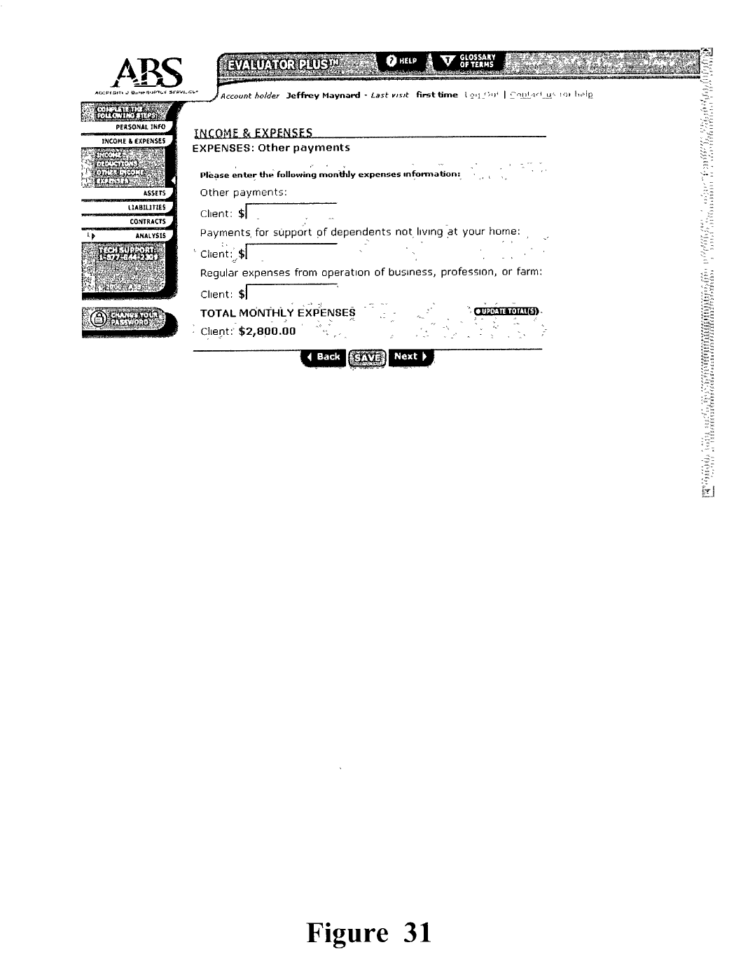

FIG. 22 is a flow chart schematically depicting separate data collection categories presented to a consumer user during use of the evaluation suite. Such data may include income and expenses, such as: income 111 (see FIG. 23), deductions 112 (see FIG. 24), other income 113 (see FIG. 25), mortgage and rent 114 (see FIG. 26), utilities 115 (see FIG. 27), food, clothing, medical, etc. 116 (see FIG. 28), insurance and taxes 117 (see FIG. 29), secured installment payments 118 (see FIG. 30), and other payments (see FIG. 31).

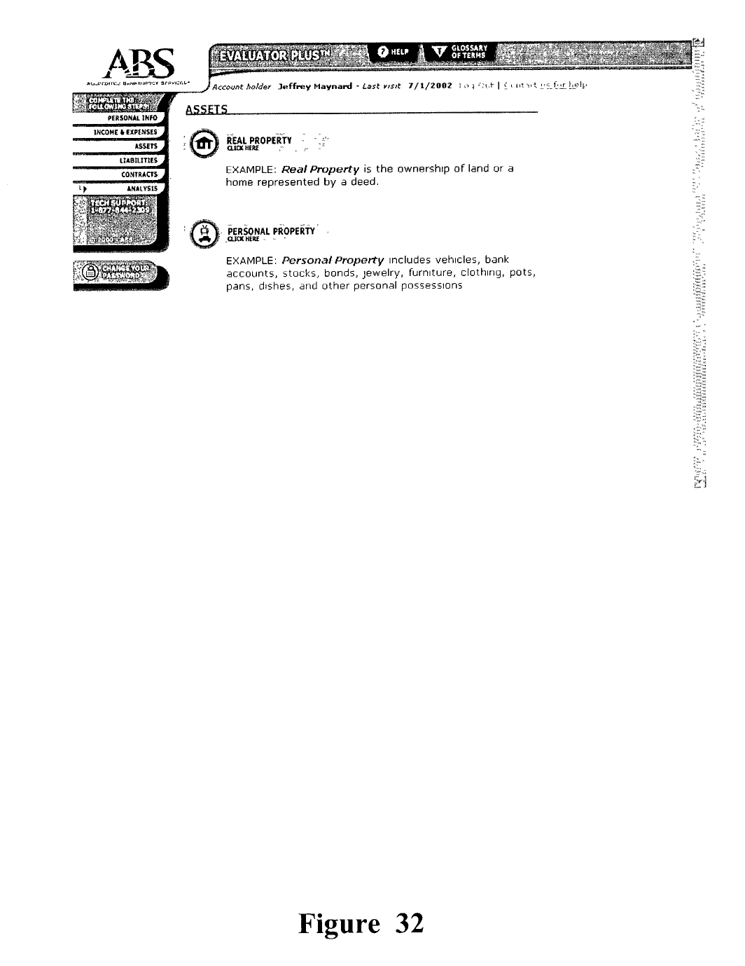

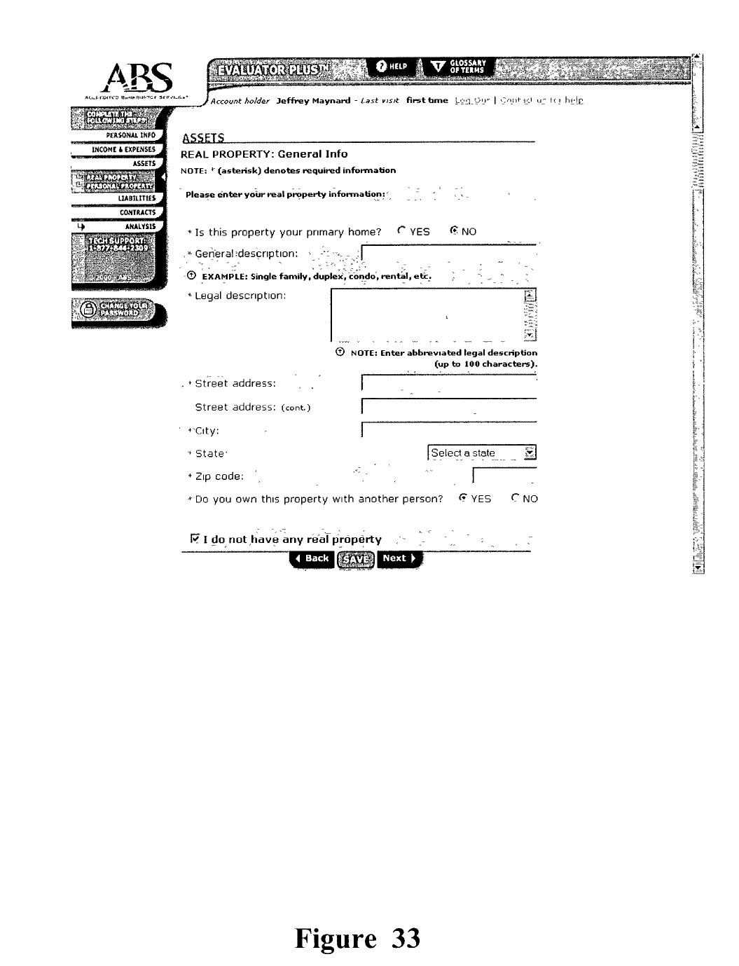

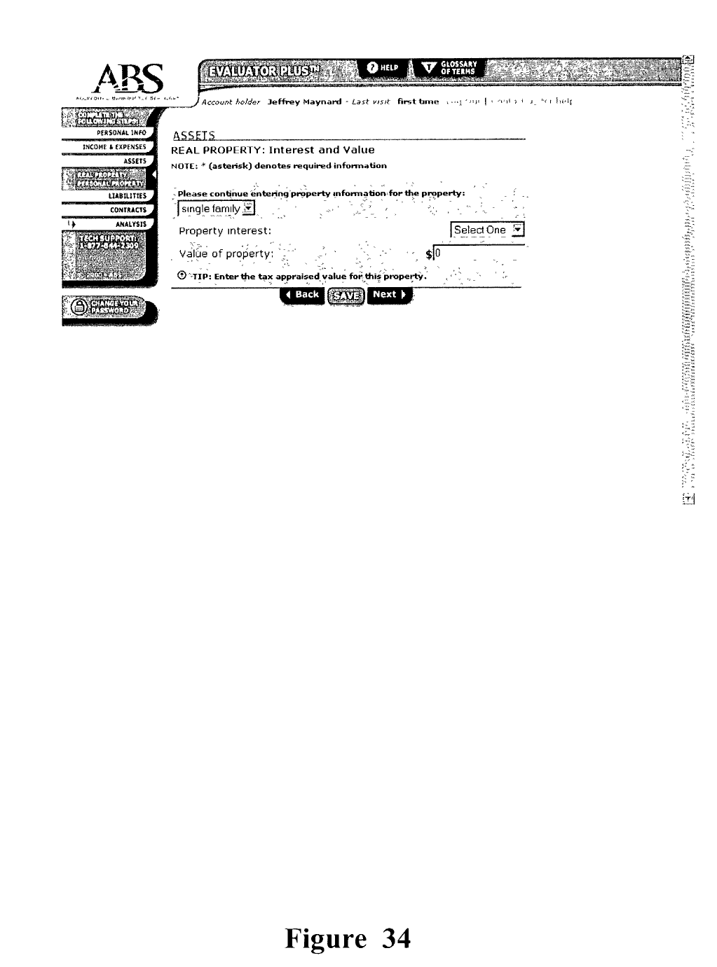

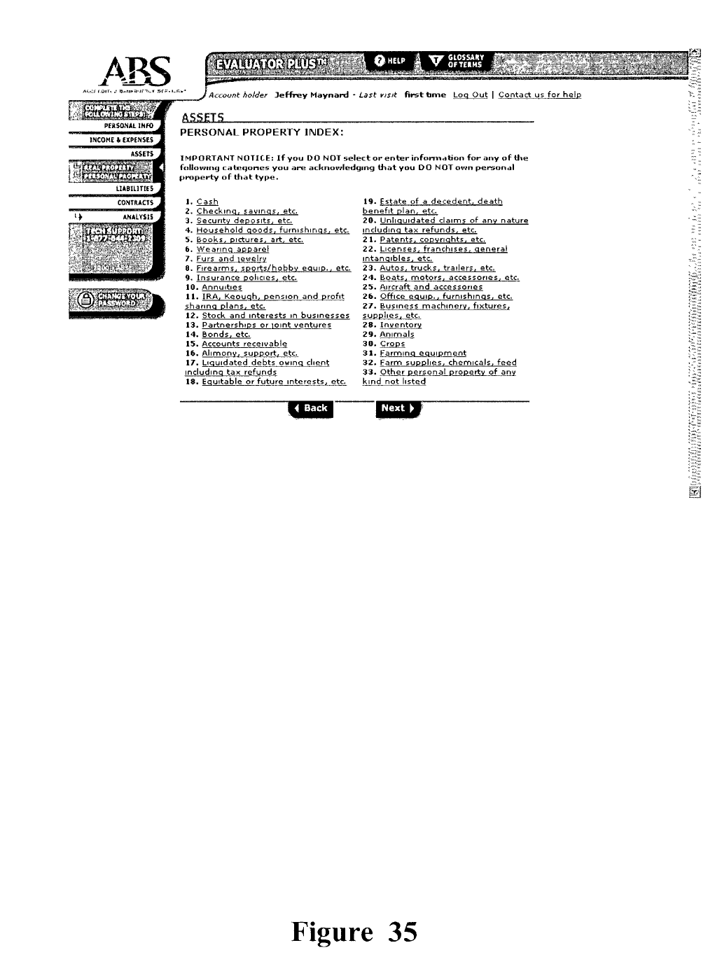

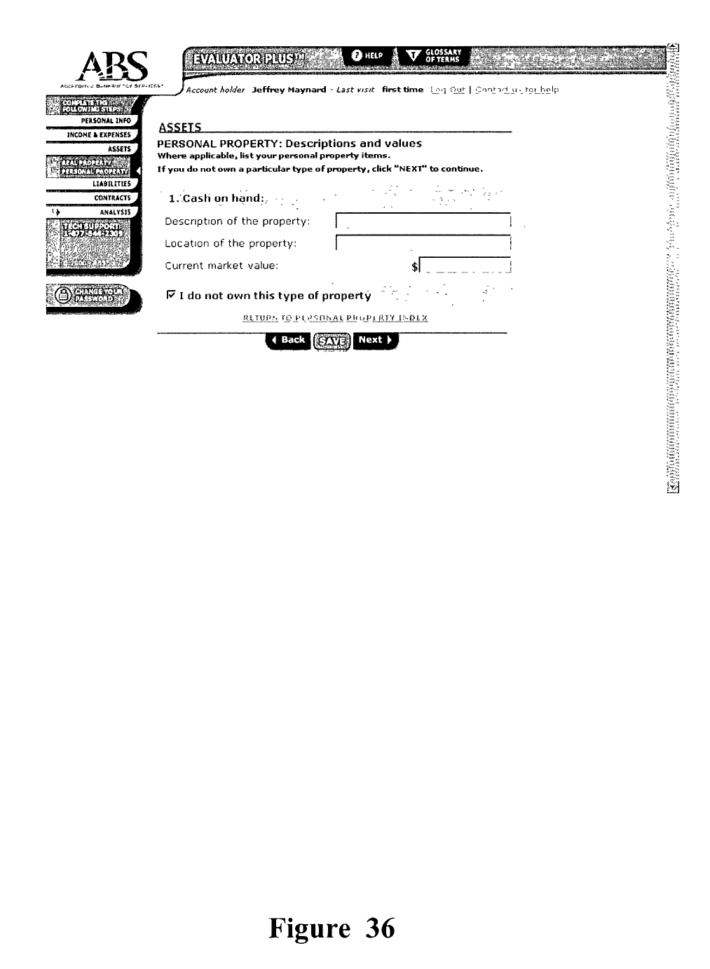

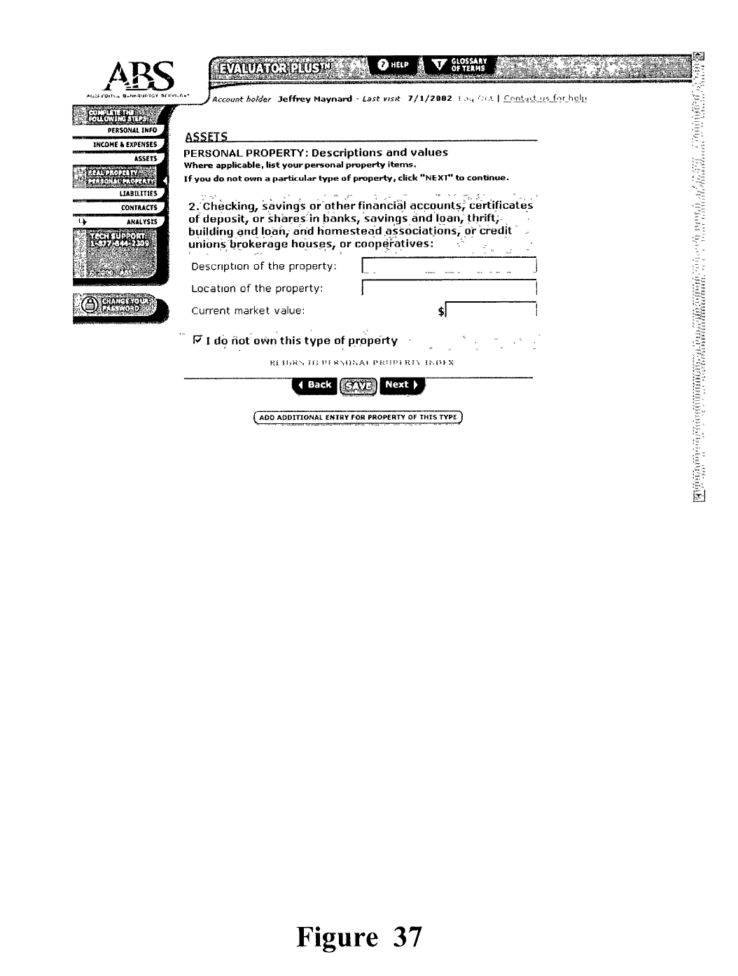

Additional data necessary for a detailed financial analysis may include information concerning assets owned by the debtor. Generally, such assets are divided into real property and personal property as shown in FIG. 32. Real property data may be entered in templates, such as shown in FIGS. 33 and 34. A variety of personal property assets that may be included is listed in FIG. 35. For example, data concerning cash on hand may be entered in a template, such as shown in FIGS. 36; data concerning checking, savings, and other financial accounts may be entered in a template, such as shown in FIGS. 37. Not all debtors may need to utilize every template listed in FIG. 35. Failure to fill in such templates is an indication that such debtor does not own any property in the particular category.

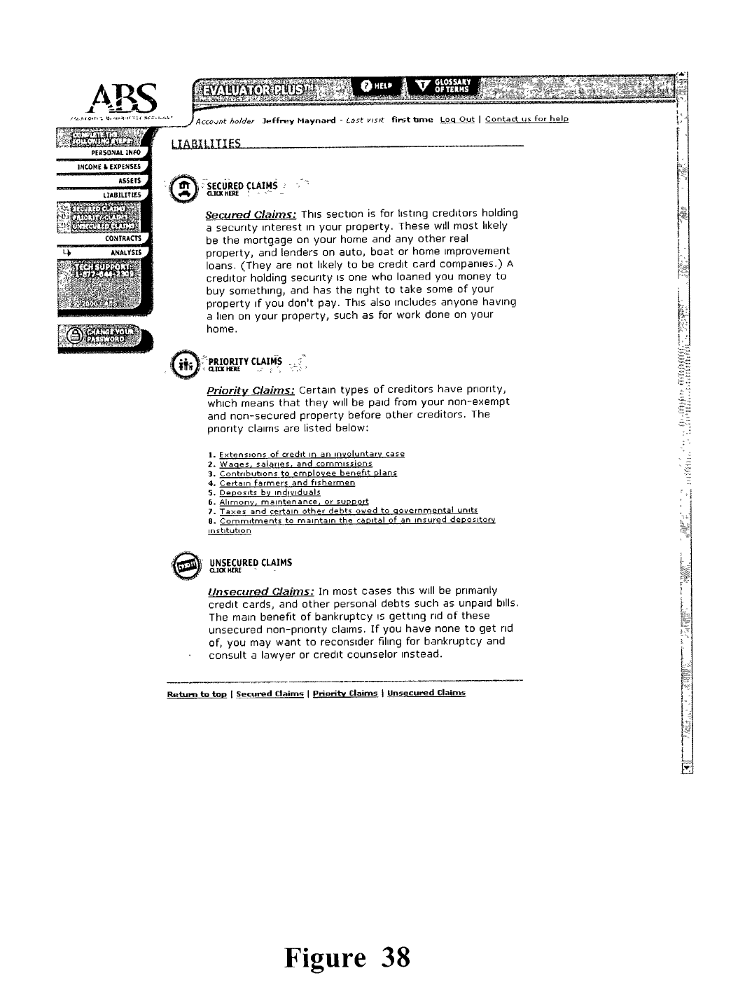

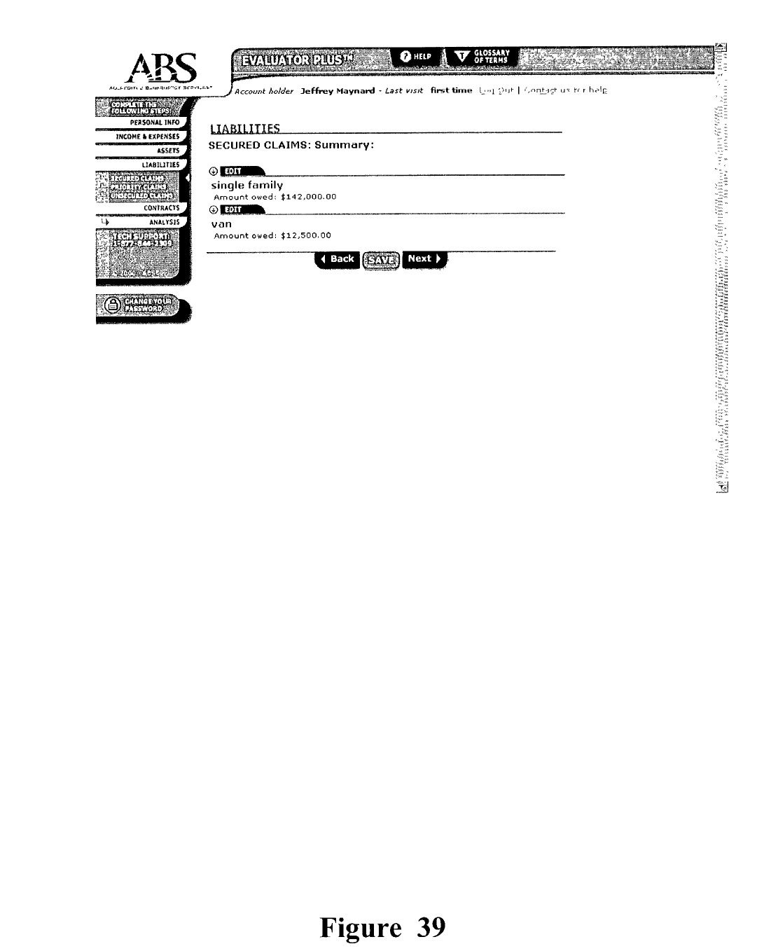

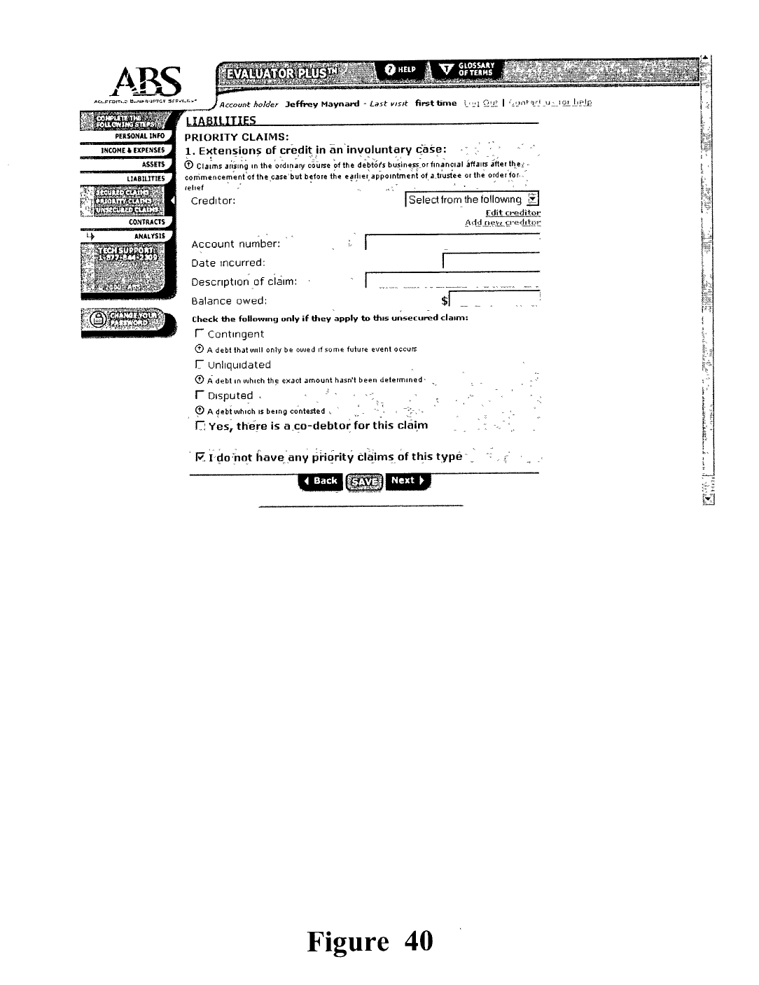

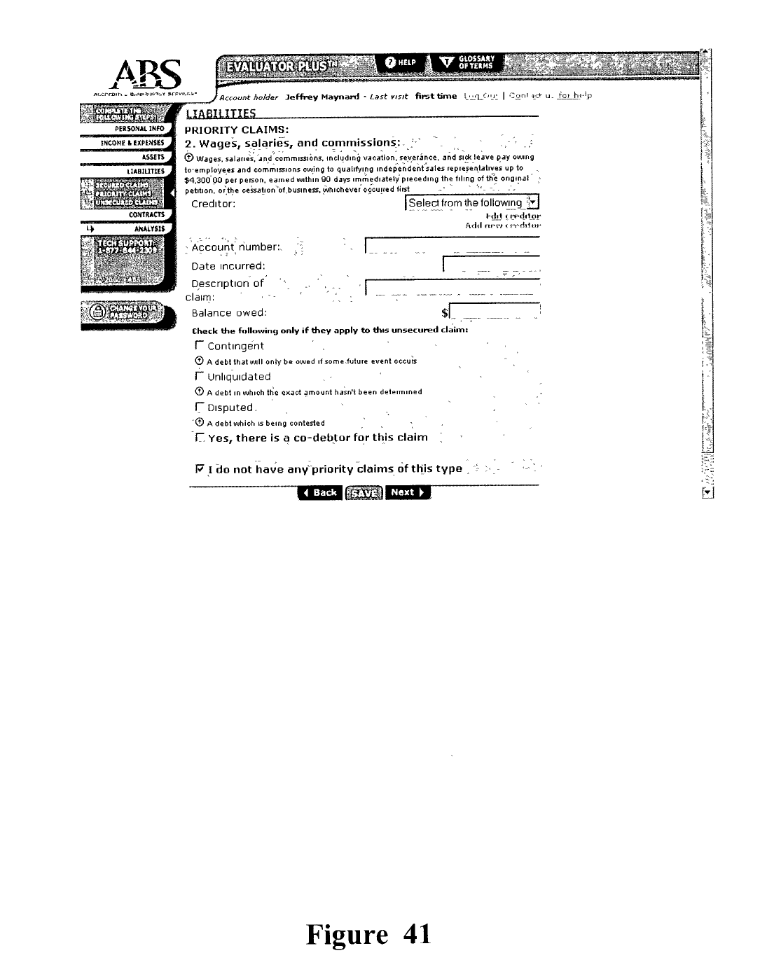

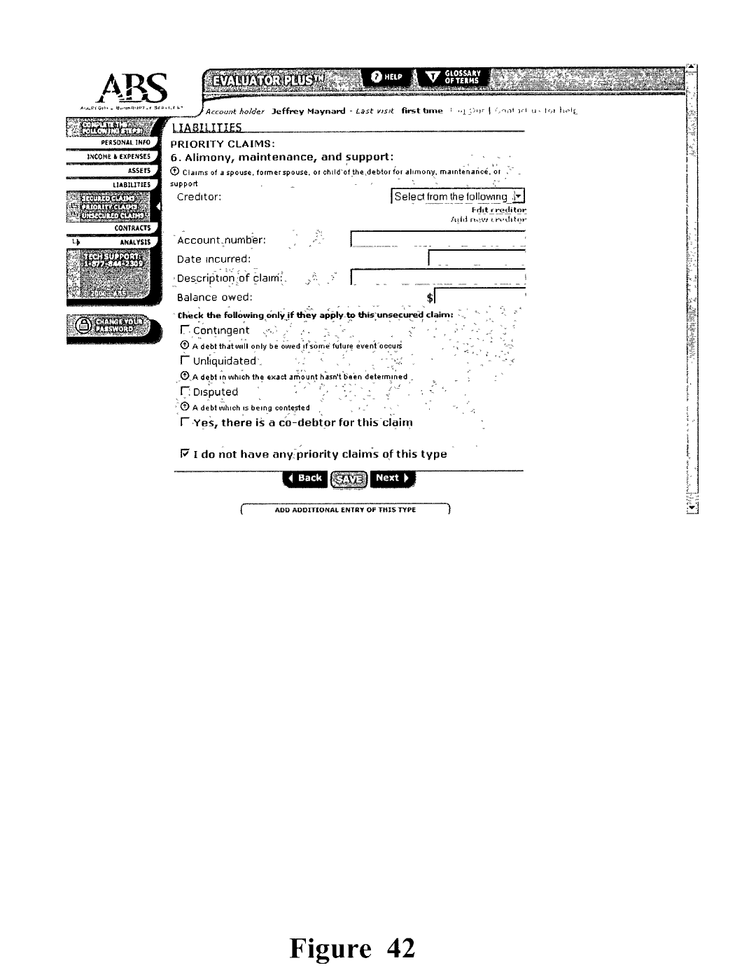

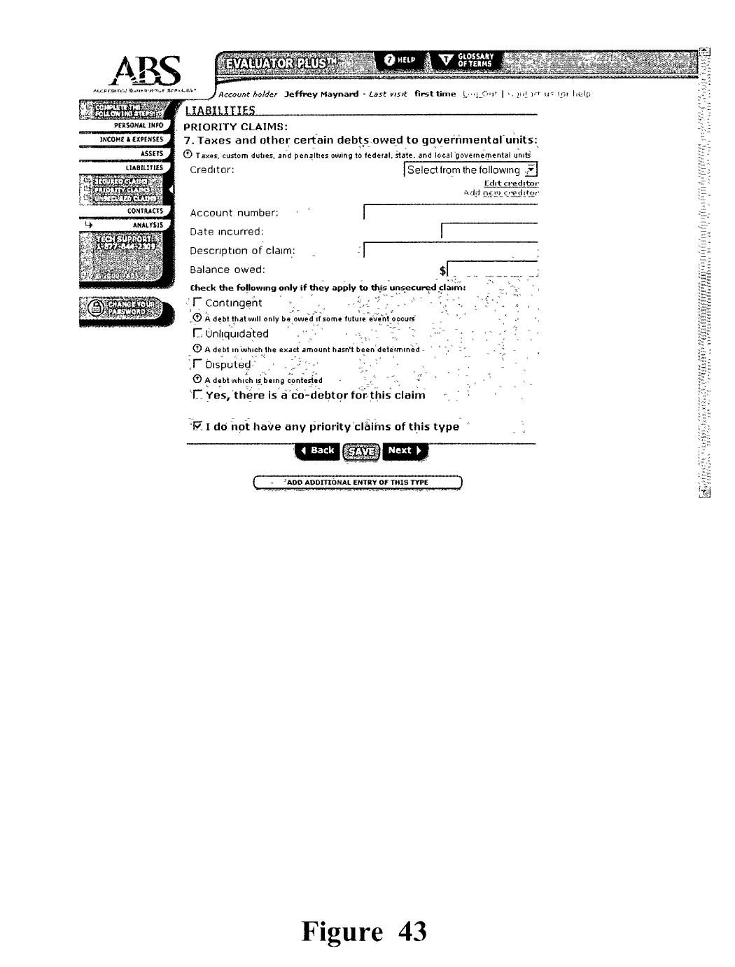

FIGS. 38-43 illustrate exemplary templates for inputting data concerning the debtor's liabilities. Such information is necessary in making a determination for filing bankruptcy, in particular for determining the appropriate chapter under which to file. Not all debtors may need to utilize every template, particularly if the debtor has no priority claims. FIG. 39 lists a summary of secured claims. FIGS. 40-42 are examples of other priority claims against the debtor's assets. Unsecured claims are input in a similar fashion to priority claims.

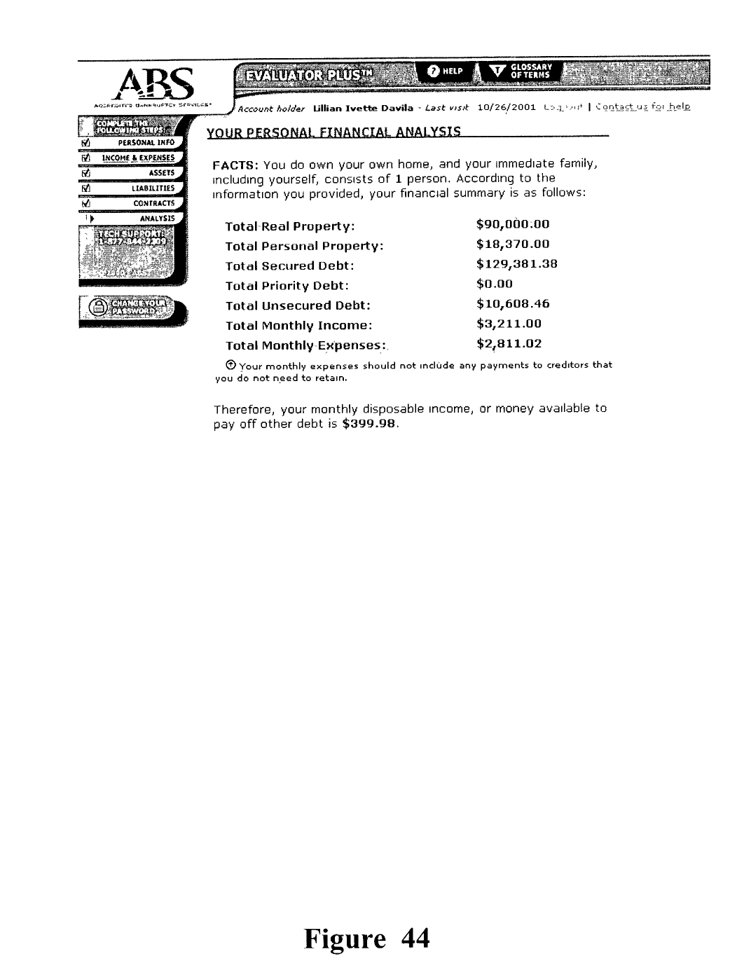

Once such data is collected, the evaluation suite processes the information input by the user to calculate the user's financial condition, and provides customized output corresponding to that financial condition. Output of the Evaluation Suite contains several sections that are automatically selected based on the user's input using artificial intelligence to combine certain functions of a credit counselor with the functions of a bankruptcy attorney. The first section provides a data summary and computes disposable income. If the debtor does have money left over after needed expenses, then the program computes the amount. A representative data summary is illustrated in FIG. 44. Detailed analysis with explanations of bankruptcy filing options, if warranted, is preferably provided in a form as shown in the attached Appendix A, which is incorporated herein by reference. Factors to consider and formulae for performing such analysis are as follows:

Monthly payment=disposable income−$100

Equity in home=home market value−home mortgage and lien balance

Solvency=assets−liabilities

Trustee fee=monthly payment (×) 6%

Qualifying for 60 months plan: (Monthly payment−Trustee fee−sum of each priority debt/60−sum of each secured debt/60)>0

Qualifying for 36 month plan: (Monthly payment−Trustee fee−sum of each priority debt/36−sum of each secured debt/36)>0

The amount to be financed=Total value of property (×) 80%−total balance of any outstanding mortgages and liens

Qualifying for attorney assisted settlement−the amount to be financed should be= or >73.3% of unsecured debt including priority debt

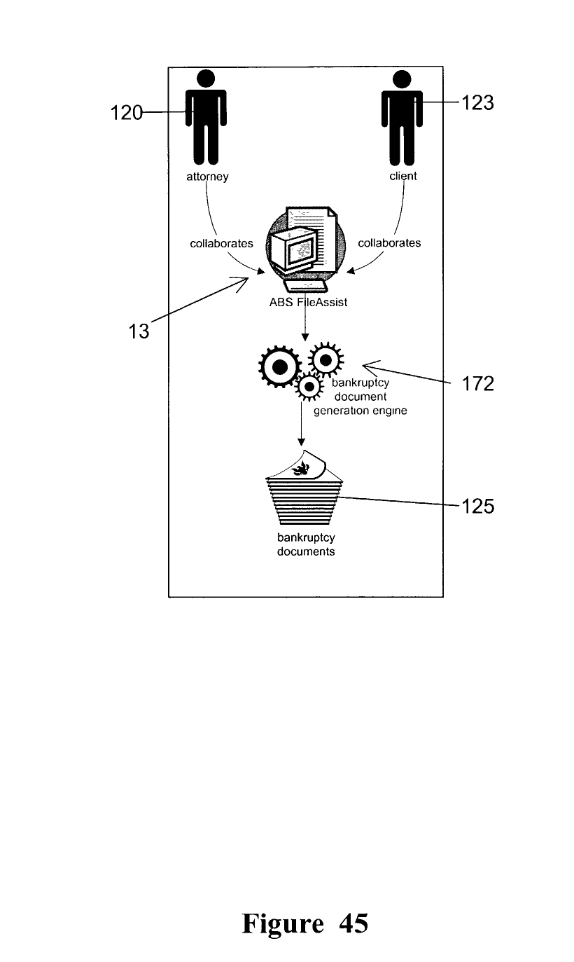

The bankruptcy filing assistance suite 13 (FIG. 1) facilitates a real-time tool for an attorney and client that utilizes web-based technology to provide electronic means to file bankruptcy using the Internet. The bankruptcy filing assistance suite 13 is referred to as FileAssist ASP. A schematic view of the FileAssist ASP element is shown in FIG. 45. An attorney 120 can collaborate with a client 123 to gather data using the bankruptcy filing assistance suite 13 to create all the documents 125 necessary for filing bankruptcy.

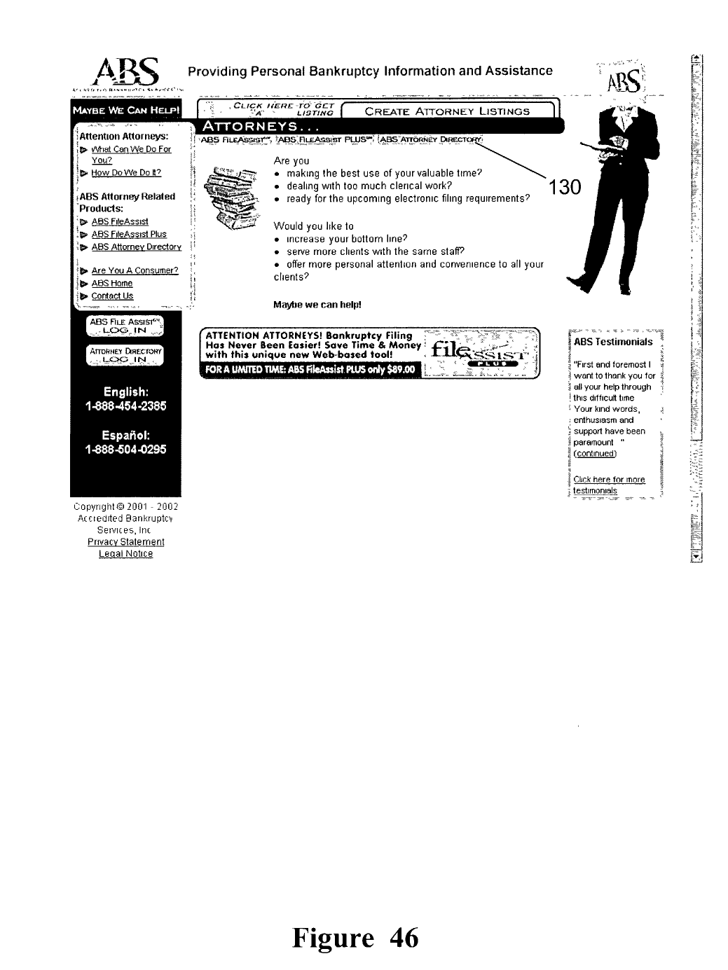

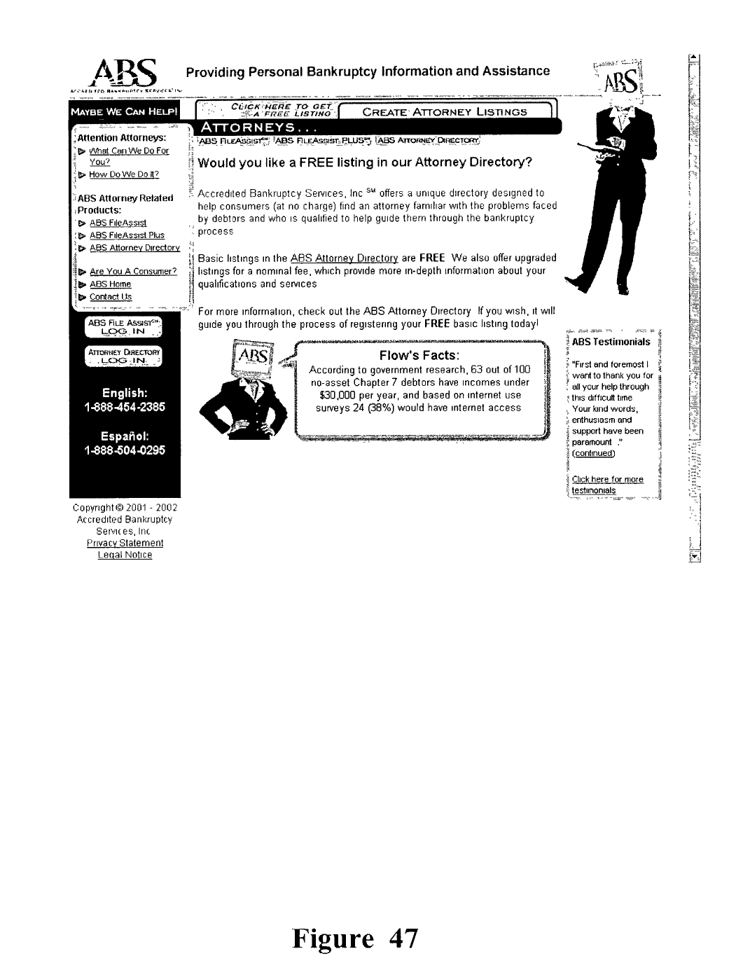

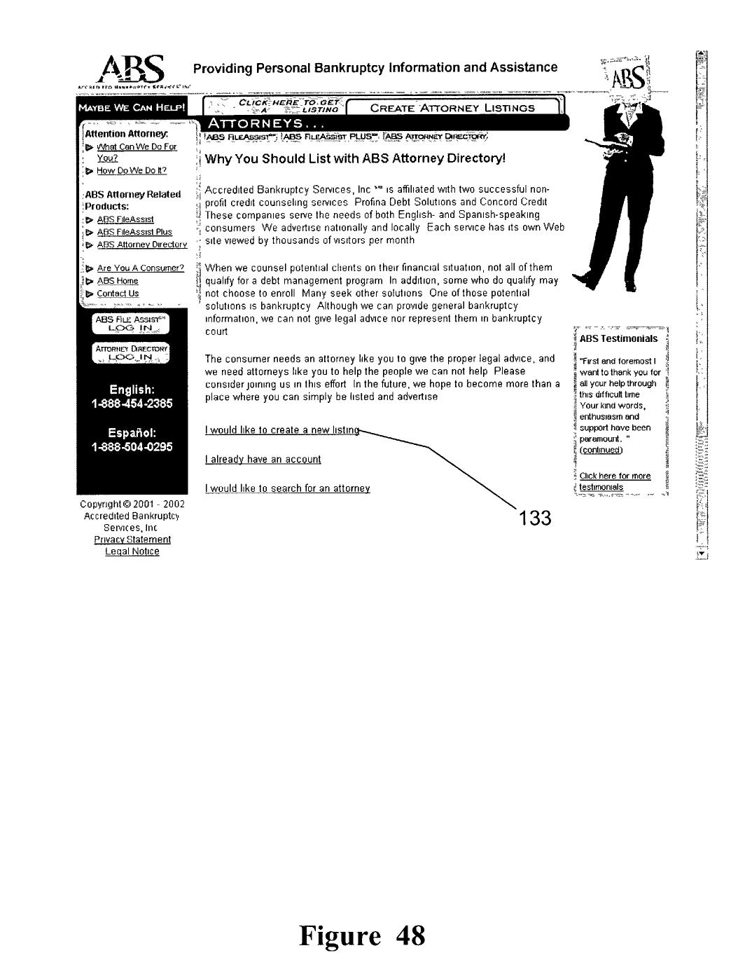

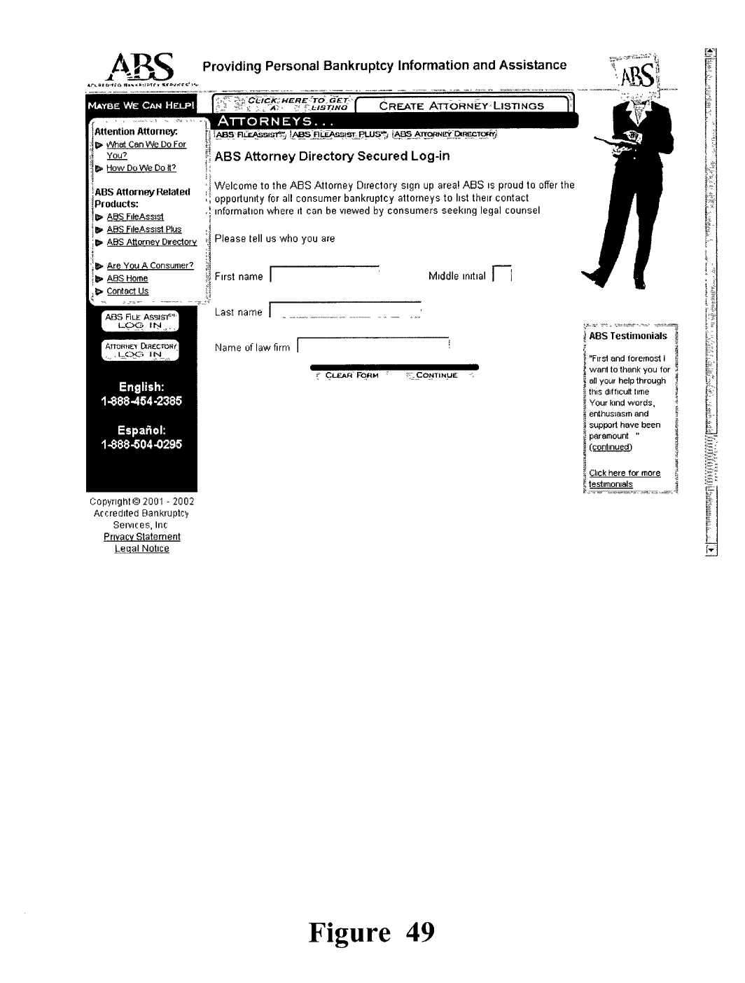

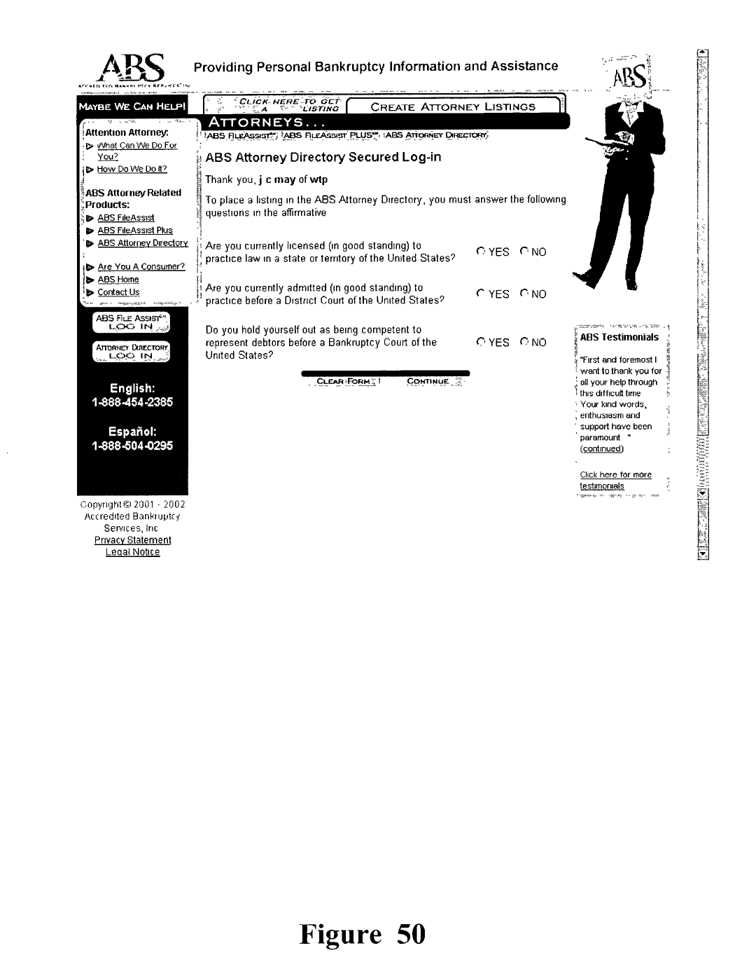

Only attorneys that have subscribed to the service provided by the system described herein can access the templates and forms provided for filing for bankruptcy. A separate link is provided for attorneys. Attorneys can link to information, such as indicated on FIG. 46. By selecting the Attorney Directory tab 130 at the top of FIG. 46, an attorney user is directed to information screens FIGS. 47 and 48. An attorney can create a directory listing by selecting the appropriate link 133 on FIG. 48. To ensure that only qualified attorneys are included in the Directory, an attorney must provide full name and firm name in a template, such as illustrated in FIG. 49, then verify personal qualification to represent debtors in a bankruptcy court using a template, such as illustrated in FIG. 50.

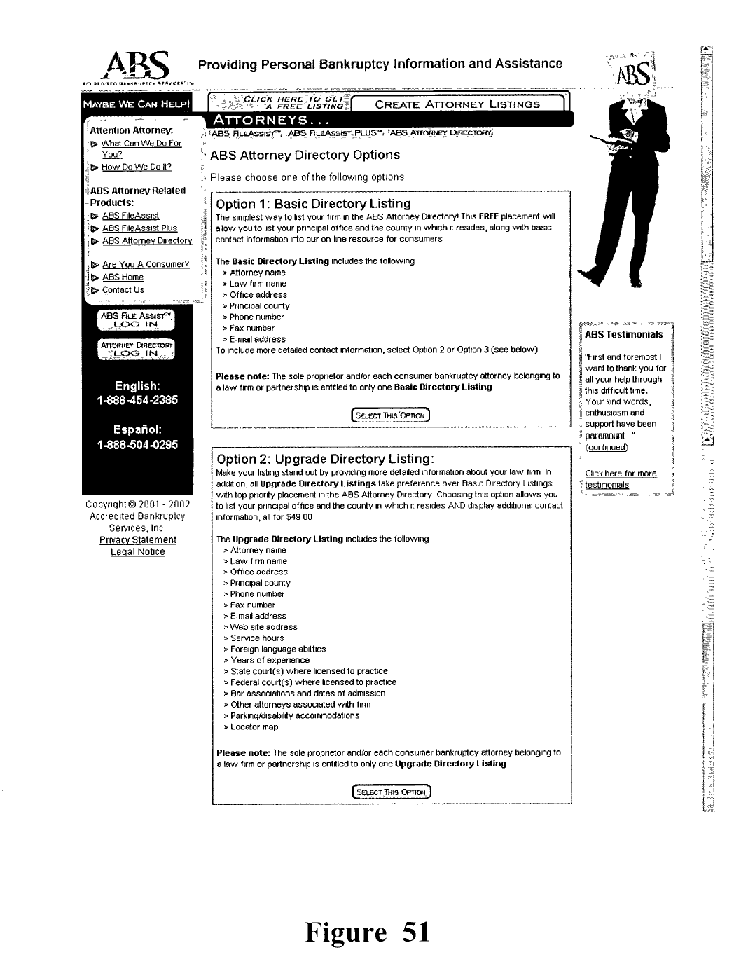

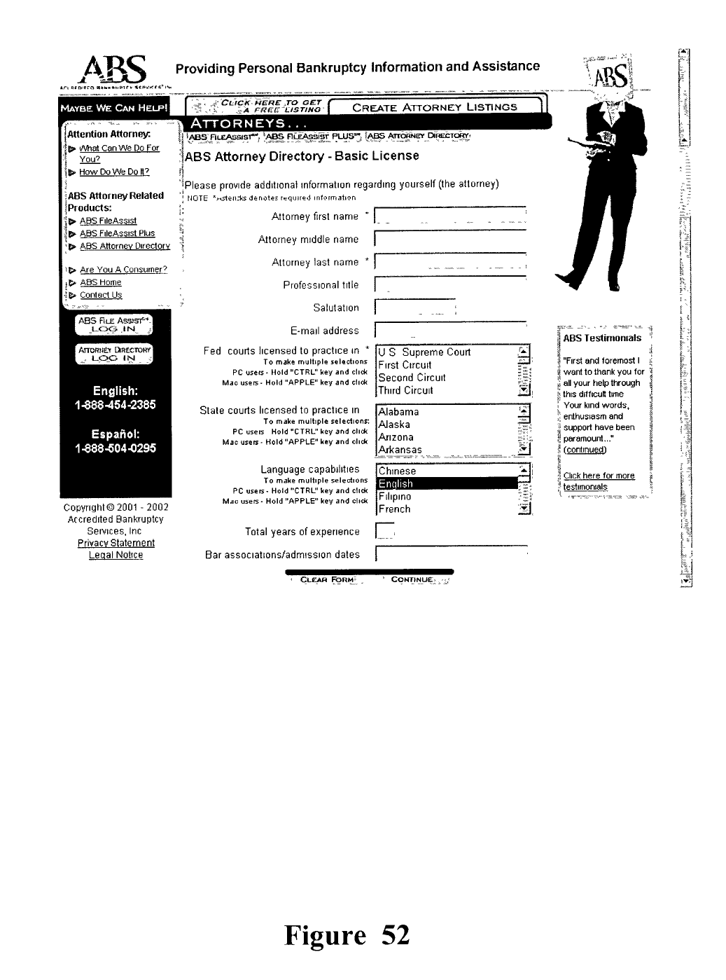

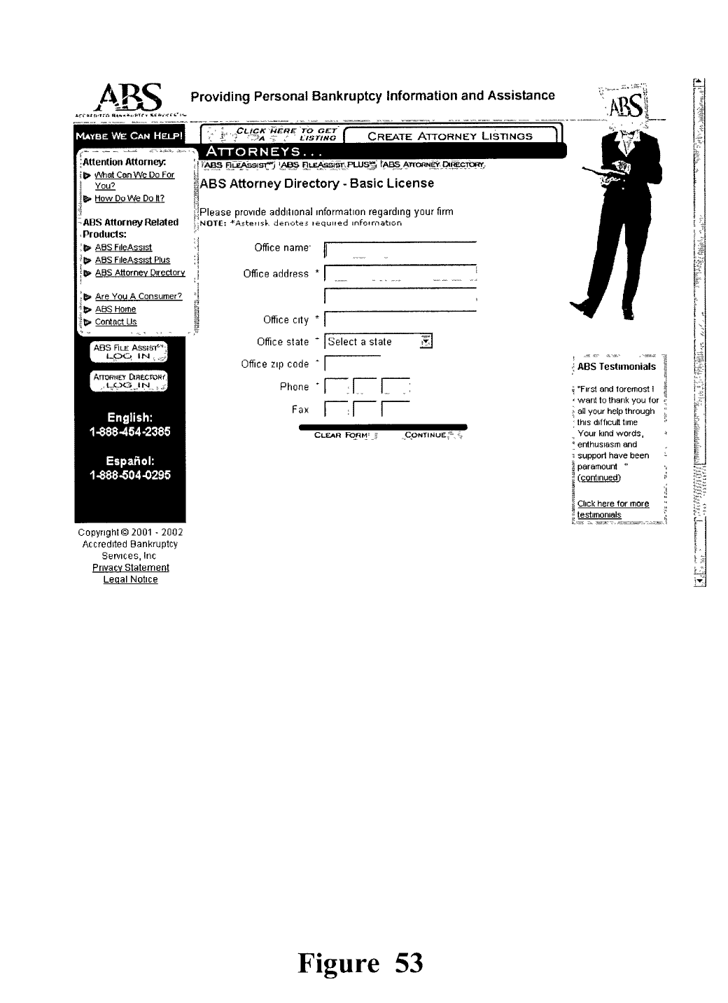

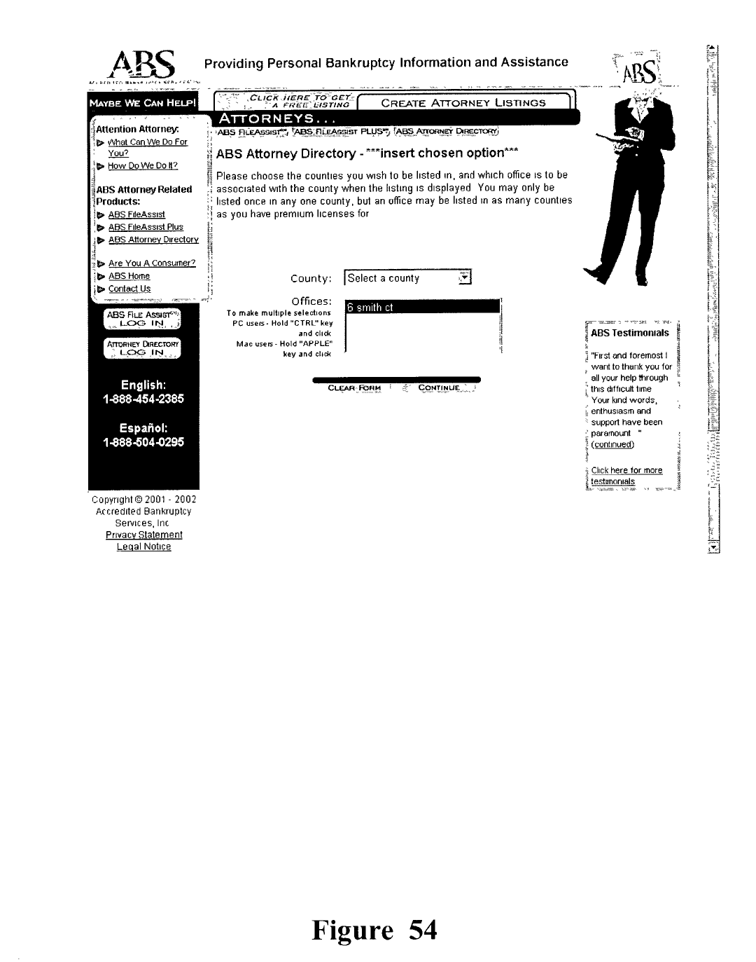

Options are available for the type and quantity of information desired by a particular attorney to be included in a directory listing as shown in FIG. 51. Once an attorney selects a preferred directory option, further links to templates such as illustrated in FIGS. 52-54 are used to gather information concerning the attorney's qualifications and contact information.

Two products are available to authorized users of the bankruptcy filing assistance suite: FileAssist and FileAssist PLUS; and two different types of users may log into the FileAssist component, namely, attorneys and clients. FileAssist assumes that the attorney's client purchased Evaluator PLUS to enter financial information and obtain a financial situation analysis. With FileAssist, that client's data from Evaluator PLUS populates appropriate fields in FileAssist templates. FileAssist PLUS offers a clean template where a client enters all necessary information.

Information previously entered by the client using Evaluator PLUS is used to populate corresponding fields in FileAssist, at which time the debtor may enter additional information. FileAssist PLUS allows complete financial data collection for clients who have not used the Evaluator PLUS service.

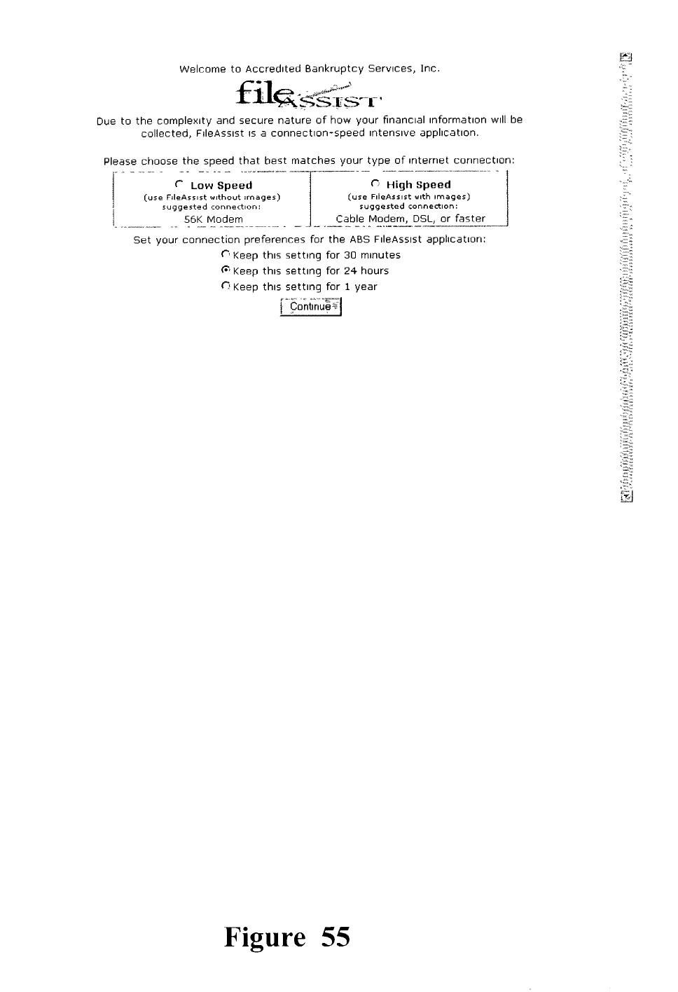

In a preferred embodiment of the invention, upon purchasing the FileAssist product and prior to logging into the application for the first time, the user, whether an attorney or a client, is presented with an option to choose a layout best suited for the Internet connection speed to be used, as depicted in FIG. 55.

Whether a user selects the low speed or high-speed connection, a “cookie” is written to the user's computer indicating the connection choice. The user is also provided the option of preserving such choice for the next year, for 24 hours or for keeping the setting for 30 minutes. The low speed choice utilizes a plain-text navigation layout. The high-speed choice utilizes a graphically enhanced navigation user-interface for computers that support higher Internet connection speeds. Performance of FileAssist and FileAssist PLUS is greatly optimized when a user selects a connection speed appropriate for the modem/connection being used.

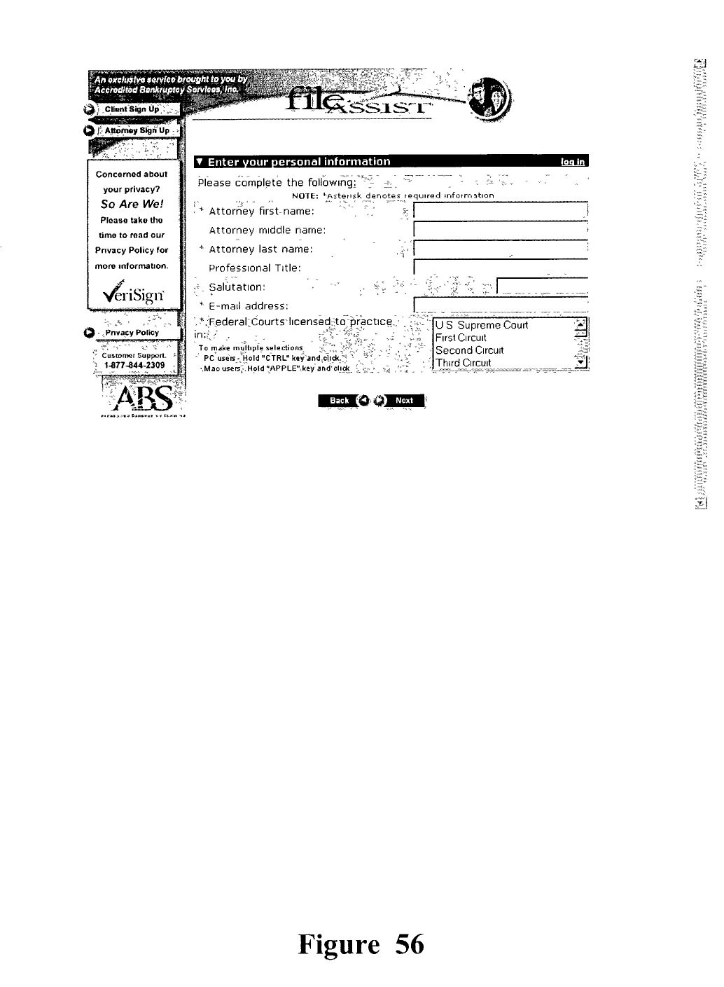

When an attorney who is not in the Attorney Directory logs in for the first time, a template, such as shown in FIG. 56 is used to collect information, such as the following:

Attorney name, title

Firm address, phone, fax

E-mail address, Web site address (URL)

Years of experience, bar associations

State and Federal court licenses

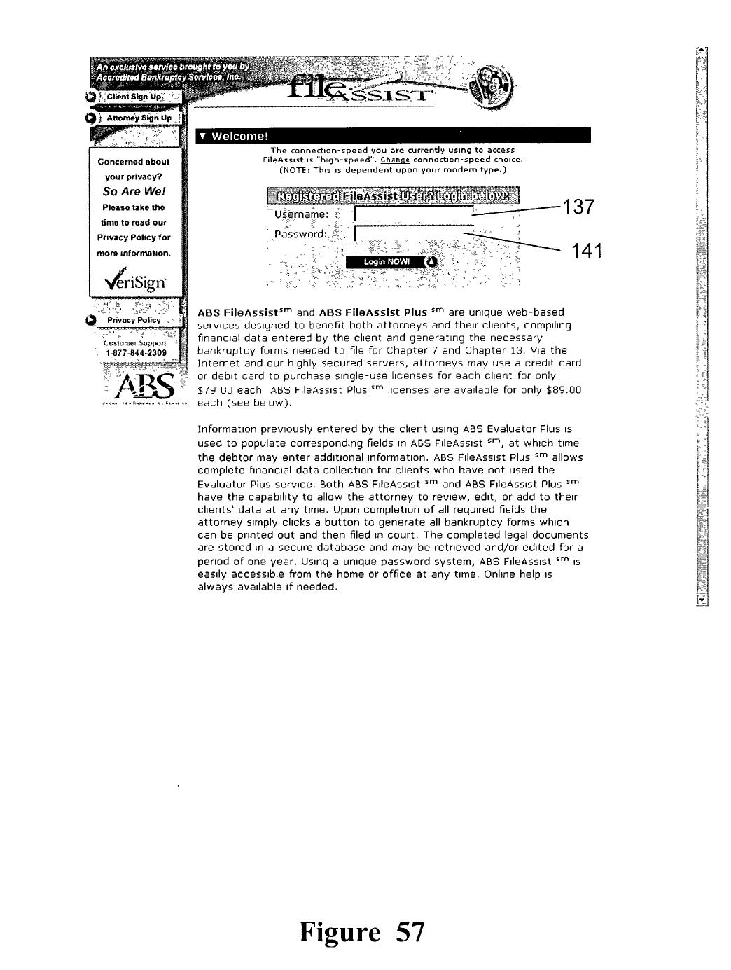

A user name and password is then generated preferably based on the attorney's first and last name. Referring to FIG. 57, the attorney enters such generated username 137 and password 141 to log into the system. The username and password are verified by comparing the entered parameters with the user name and password stored in the database for that attorney. If there is not a match, the attorney is asked to try again. Failure to enter a correct username 137 and password 141 inhibits access to the system to prevent unauthorized use.

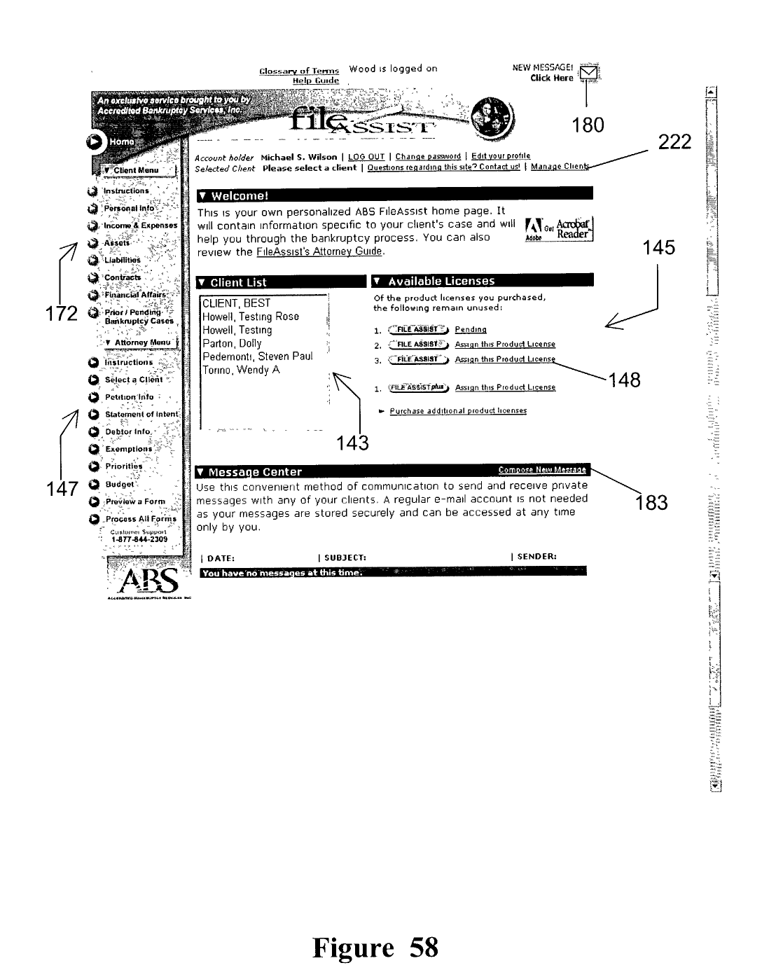

When an attorney logs into FileAssist ASP, a screen (as shown in FIG. 58) specific to that attorney's clients and purchased product licenses are displayed. The attorney can select a client from a visible text area control 143 on the screen in order to view client specific information or assign available licenses 145 to new clients.

If a client is selected from the Client List 143, the attorney can use the attorney-specific navigation 147 of the user-interface to view completed information for the selected client.

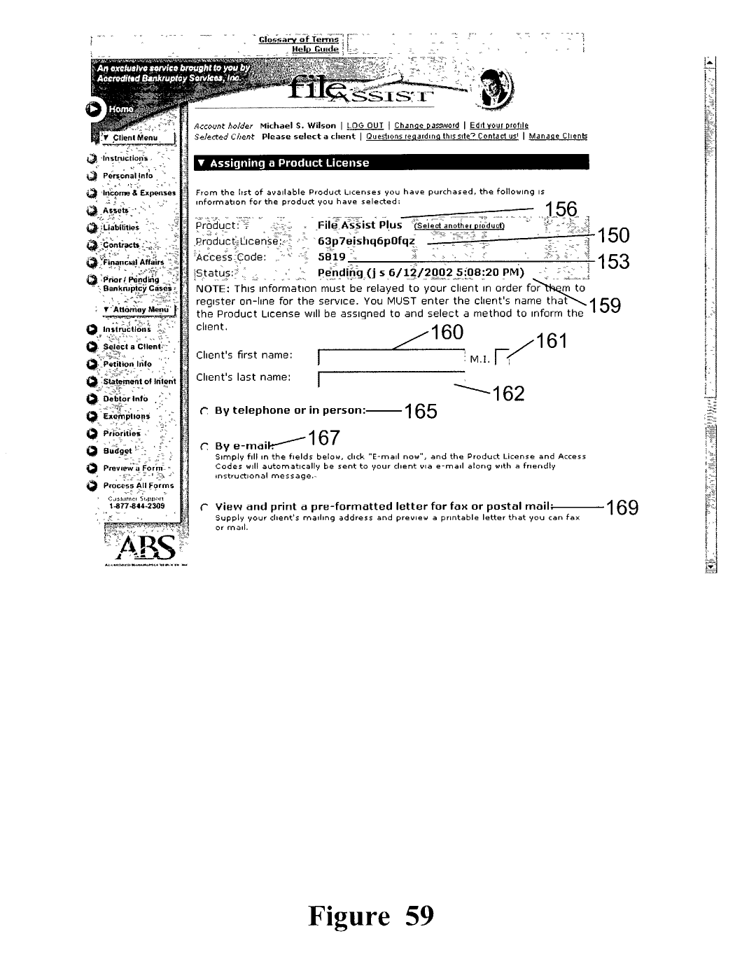

Once logged into the system, an attorney assigns a product license to a selected client. As shown in FIG. 58, an attorney assigns a product license by clicking on the “Assign this Product License” link 148 that appears next to one of the products on the available licenses list 145. The link directs the attorney to a screen such as FIG. 59 where a Product License number 150 and Access Code 153 generated by the system are displayed for the selected Product 156. If the license has been assigned, a Status 159 is also provided. Such attorney is prompted to enter a client's first name 160, middle initial 161 and last name 162. Since a client cannot log into the system without an access code and license number, the attorney is provided options for informing the client of the client's new license number and access code for logging into the system. The attorney can notify his client of such information by one of three methods; verbally, in person or over the telephone 135, by e-mail 137, or by printing a letter and mailing it to the client 139. The attorney is prompted to choose one of such three options on the same screen used to enter the client's name. If the attorney chooses to e-mail or print a letter, such attorney is prompted to enter the client's e-mail address or mailing address. The attorney then clicks a submit button on the screen. If the attorney selects to e-mail a notification to the client, an e-mail is automatically sent to the client by the system. If the attorney selects to print a letter, the system automatically generates a form letter for preview, which the attorney can edit and print for mailing. If the attorney chooses to verbally inform the client, then the attorney is informed of the client's license number and access code. The attorney is cautioned to be accurate in relaying information to the client, since the license number is quite long and must be exactly entered for access to the system. All three methods are intended to inform the client of the client's access code and license number.

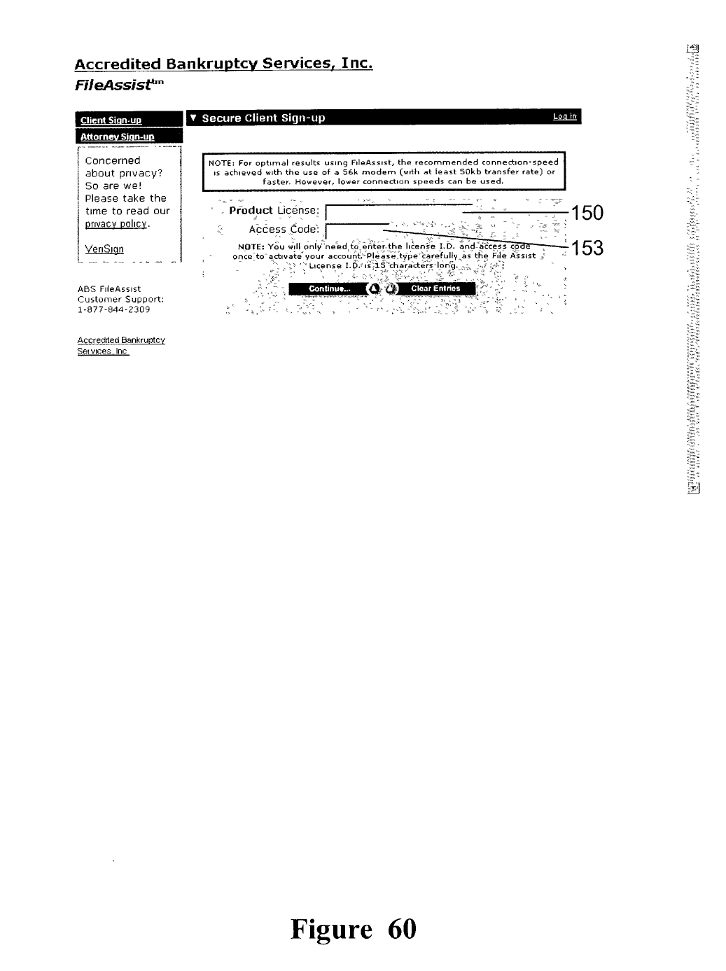

The client then uses that license number and access code to log into the system (as shown in FIG. 60). The client must enter the assigned Product License 150 and Access Code 153 to enter the system. The Product License number 150 and Access Code 153 are verified by comparing such assigned parameters to ones stored in the database for such client. If there is a match, the client is permitted access. If there is not a match, the client is asked to try again. Failure to enter a correct Product License 150 and Access Code 153 prevents unauthorized access to the system.

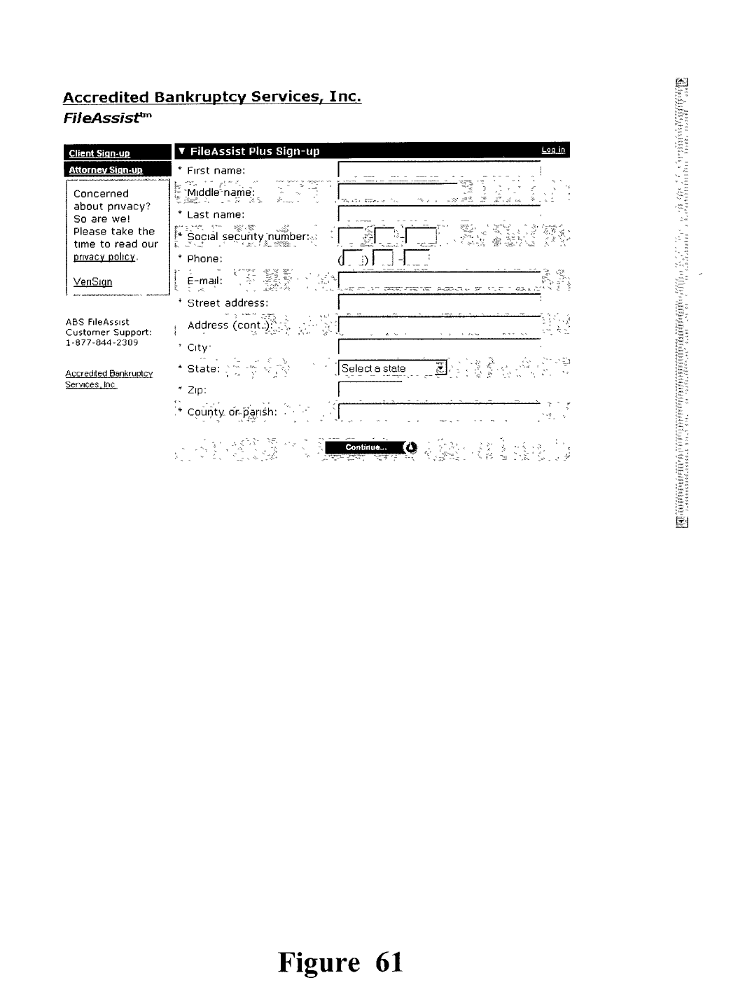

If the client had not previously purchased Evaluator PLUS to enter detailed financial information, such client can enter financial data directly in FileAssist PLUS using a client sign-up page such as FIG. 61.

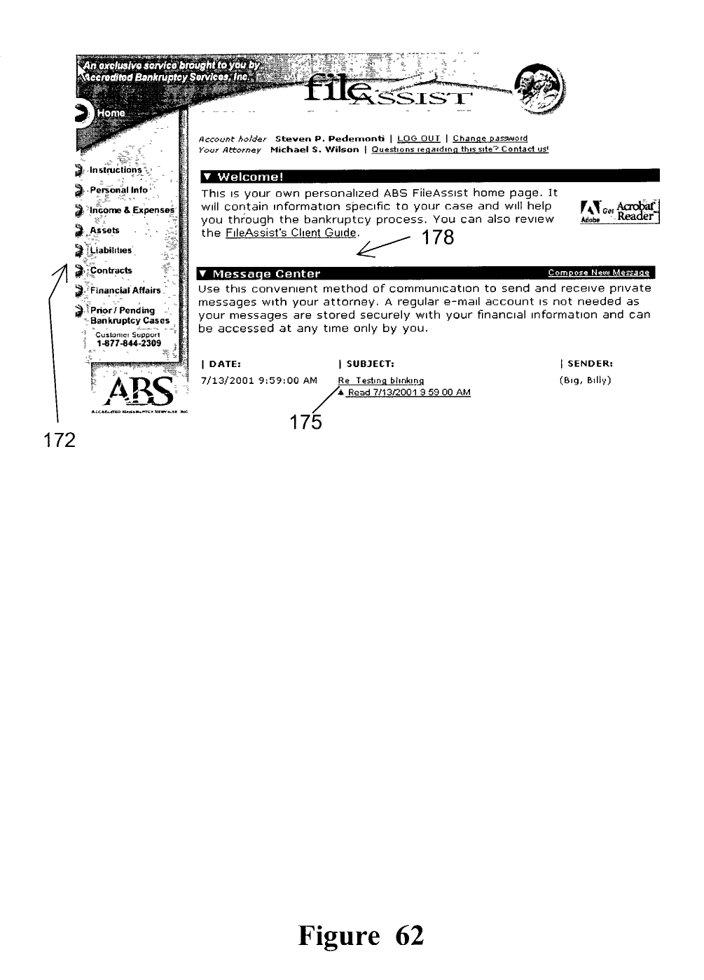

The client, once logged in, is directed to a custom home page for navigation, such as shown in FIG. 62.

There are differences between navigation for the attorney and the client, since the attorney can perform additional functions than the client. The client's personal home page presents custom navigation links 172 to templates that collect necessary information for the Chapter 7 or Chapter 13 filing process. Additionally, new unread messages 175 (or messages less than 72 hours old) from the attorney will appear on the home page.

A communication feature may also be provided in the form of a “Message Center” 178. The Message Center 178 feature of FileAssist provides a communication system that allows clients and attorneys to discuss the client's bankruptcy case. The user interface alerts both the attorney and the client when new message(s) exists in their account.

Once the attorney or the client enters their account, a list of read and unread messages appear. Those messages that have not been read are marked accordingly. Read messages remain in the account for 72 hours.

Each message is stored in the database for two months (if not read by receiver) or three days (if read by receiver).

Typically, an attorney will have several of more clients with which to communicate. Upon sending a new message, the application user interface allows the attorney to select the desired client to which a message will be sent if this was not done after login.

As shown in FIG. 58, the messaging feature for the attorney is accessed via an icon 180 in the upper portion of the user-interface. After logging in, the attorney may opt to view new messages prior to selecting a client from the Client List 143.

If the attorney does not select a client prior to viewing new messages, such attorney will be able to read new messages, but will not be able to compose a message until a client is selected from the Client List 143. After a client is selected, the attorney can send a message to such client using the ‘Compose New Message’ link 183. If the attorney attempts to compose a message without first selecting a client, the attorney will be redirected to the home page, and instructional text will display.

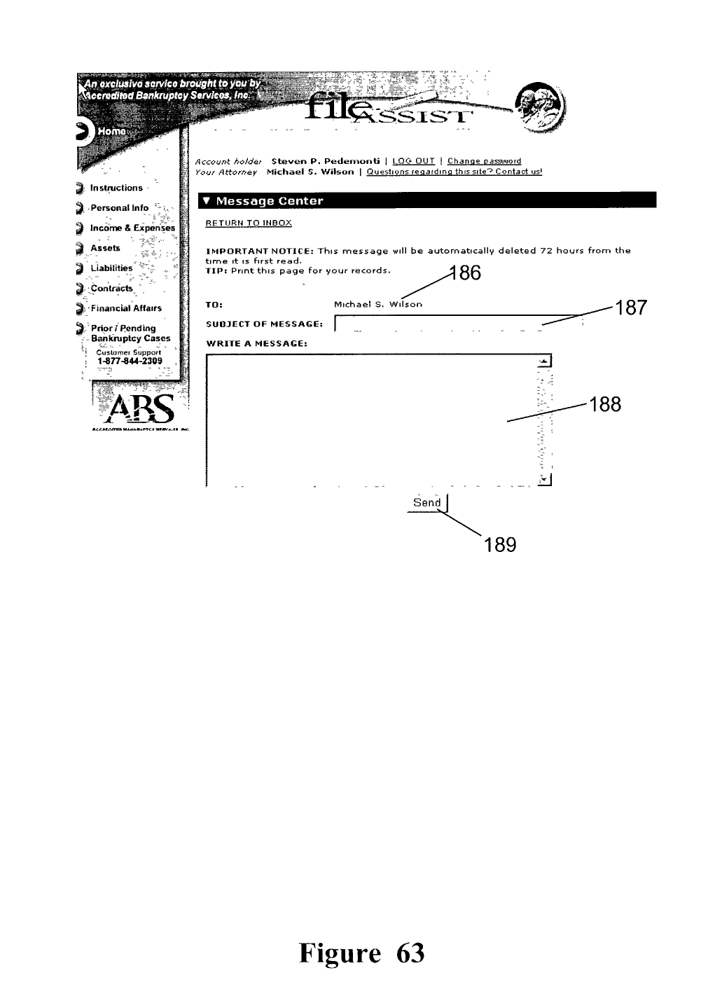

Once a client is selected, and the new message link 183 is clicked, an interface that includes the client's e-mail address 186 and areas to insert the subject 187 and body text 188 are displayed, as shown in FIG. 63. After the user is finished composing a message, clicking the ‘Send’ button 189 can immediately transmit the message.

The system of the instant invention is preferably equipped to store information input by both attorneys and clients for later retrieval, review, and editing. The electronic storage feature facilitates an electronic storage of bankruptcy data and documentation. The attorney can view information submitted by a client by selecting an item from the client navigation section 172 (FIG. 58).

The information completed by the client displays, permitting the attorney to complete forms required for filing Chapter 7 or Chapter 13 using data supplied by the client. A custom attorney navigation area 147 (FIG. 58) of the application exists for completing forms for filing.

Once both the client and attorney have entered all of the information, the attorney can preview the forms and if changes are not required, processing and filing of such forms can be completed. The system preferably offers downloadable forms in a format readily accessible by most users, e.g., portable document format (PDF). Other formats may be used as well, including (without limitation) HTML, MS Word, Corel WordPerfect, ASCII text, Rich Text format. At a minimum, users will want to electronically fill blanks in the forms. Sophisticated users may wish to amend or modify the language of a form to suit their particular needs.

Both FileAssist and FileAssist PLUS have the capability to allow the attorney to review, edit, or add to their clients' data at any time. Upon completion of all required fields, the attorney simply clicks a button to generate all bankruptcy forms, which can be printed out and then filed in court. The completed legal documents are stored in a secure database and may be retrieved and/or edited preferably for a period of one year.

Also optionally provided is an online support function. The online support function of FileAssist provides an integrated, online support for both the attorney and client for bankruptcy filing. A variety of important topics is covered from data security to a glossary of terms. Access to online support is accessible anywhere within the application for easy, instant support.

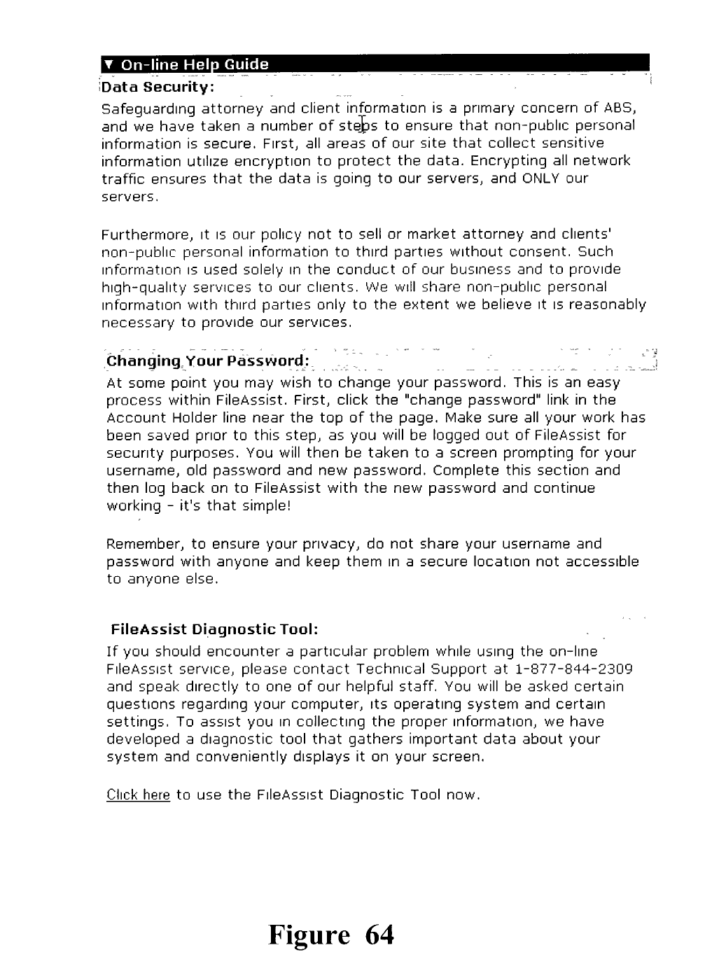

The Online Support function is a hypertext document. The same document displays for both attorneys and clients. Live communication between a user and Help Desk Technician is not enabled. However, a telephone number is provided for person-to-person technical assistance. An illustration of the Online Support function is shown in FIG. 64.

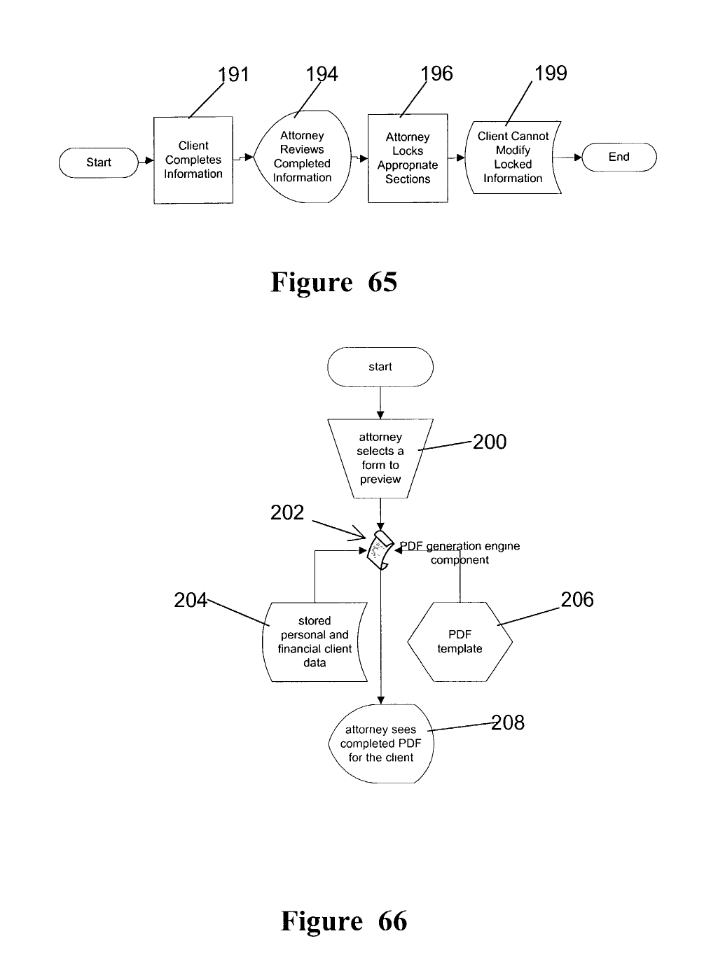

The Document Revision Control feature of FileAssist provides a document revision control mechanism that supports data control (section locking). A schematic flow chart of the Document Revision Control feature is shown in FIG. 65. Once a client has completed input of information 191, the attorney can review and edit such information, if necessary at step 194. The attorney has the ability to “lock” any section of a template when it is fully completed at step 196. After the information is locked, the client cannot modify the locked information 199. Locking the information protects client data and ensures both attorney and client have the same information at all times. If the client needs to modify information contained in a locked section, a message must be sent to the attorney using the FileAssist Message Center.

An important element of the Document Revision Control feature is the bankruptcy document image generation engine. This software uses a COM object that handles multiple requests at a time and renders bankruptcy documents with an appropriate processing date.

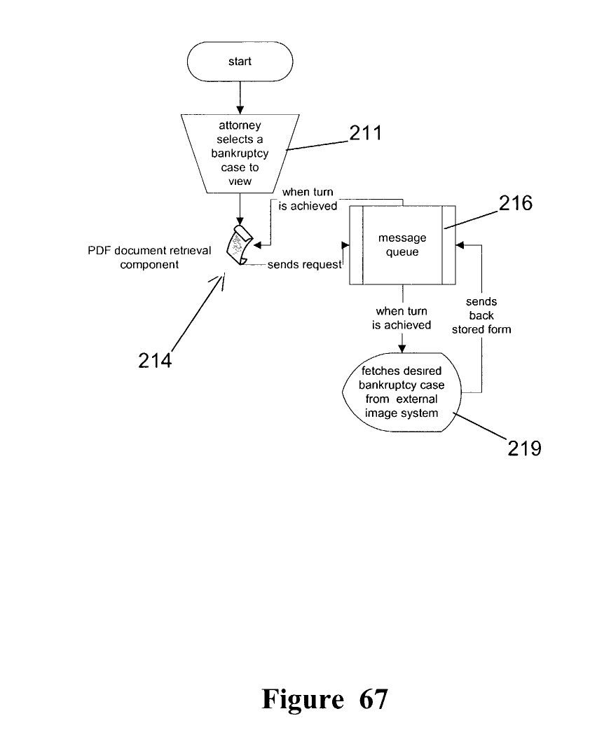

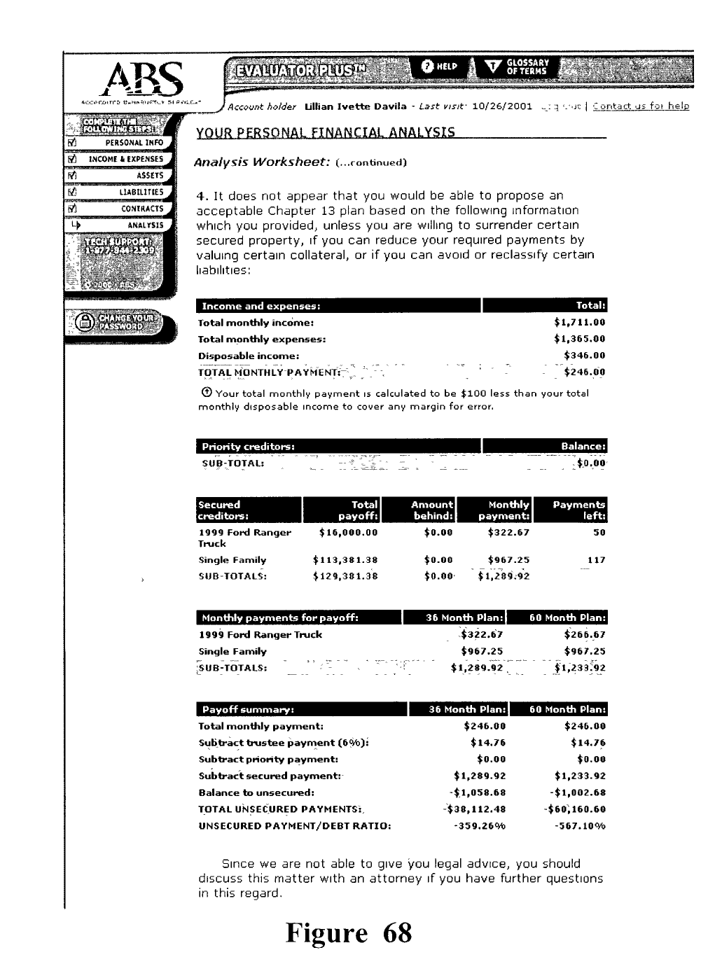

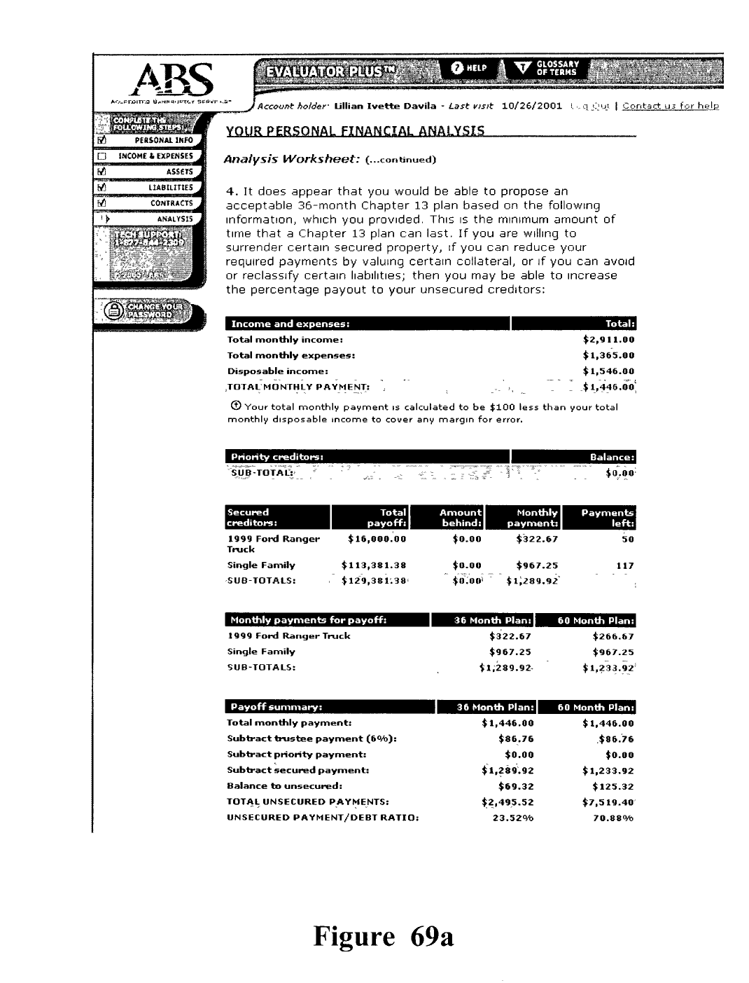

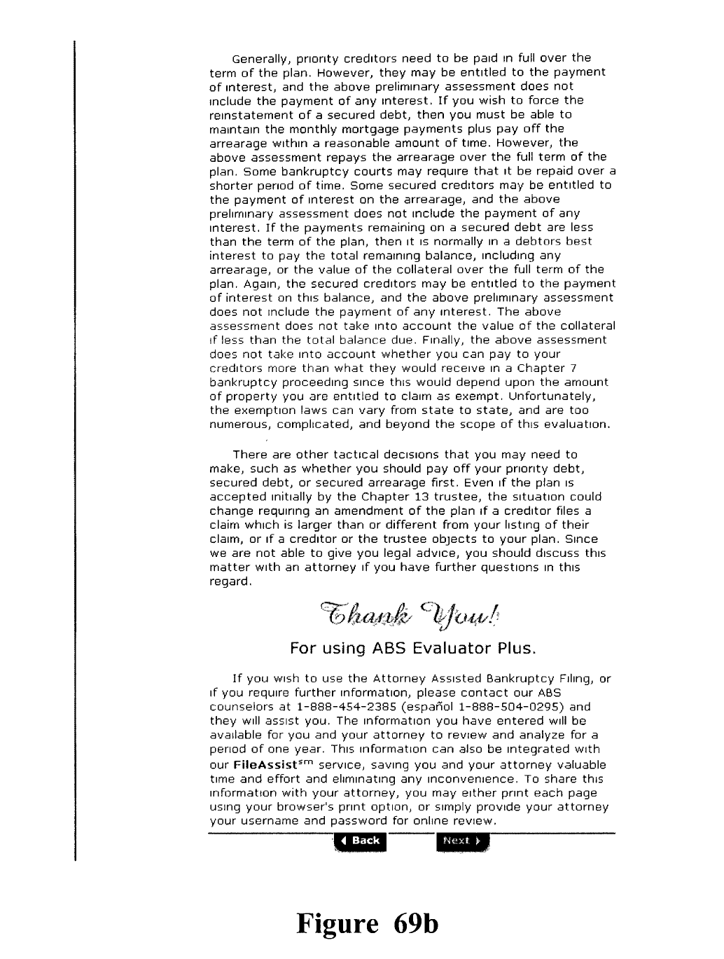

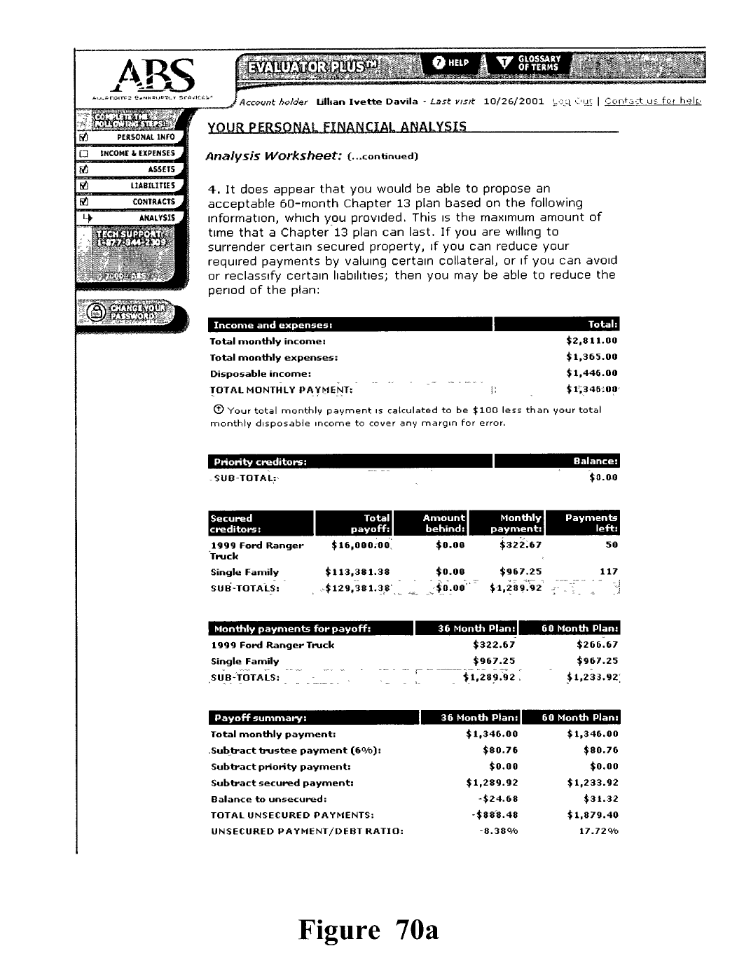

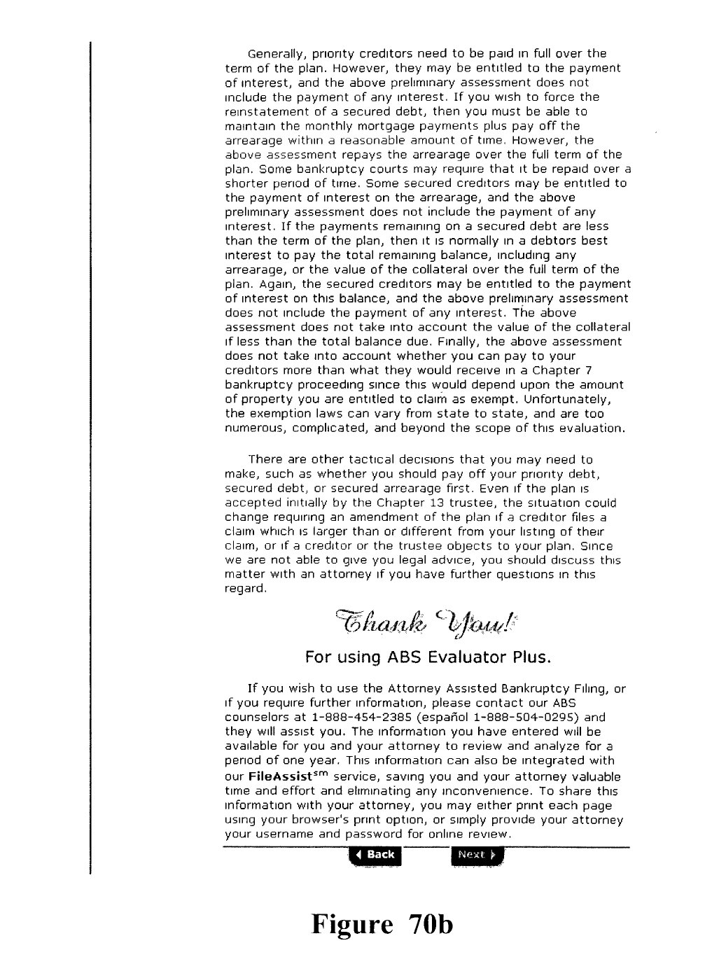

The bankruptcy document image generation engine is comprised of two parts, document generation and document storage and retrieval. Document generation is shown schematically in FIG. 66. Document storage and retrieval is shown schematically in FIG. 67.

The following discussion details the elements making up ttDocCreate.dll. ttDocCreate.dll is a COM object, written in visual basic that performs the function of generating all forms created by the FileAssist Program. These forms make up complete documentation deliverable to the courts when a client is filing bankruptcy. Specific software commands are included in Appendix B.

Each filing document is generated as a PDF form, although other document formats may be used. These documents have pre-defined format and layout. When a particular document is selected to be generated, the data that will populate such document is expected to already have been entered into the database at a prior time by either the client user or some other appropriate user, such as the attorney user.

Referring to FIG. 66, once a user, such as an attorney, selects a document to be generated at step 200, a request is received by the system and is passed to a document image generation portion of system software 202. The software 202 identifies which document has been requested for review. The software 202 also identifies which client's information 204 to use to populate the document by matching a client id submitted with the request. The software 202 then finds an appropriate PDF template 206 in the system database. The software 202 retrieves the particular client's information 204 that should appear on the selected document from the system database. Once the document image generation portion of the software 202 has retrieved the client's information 204, the PDF template 206 is populated with the data. For example, the client's first name field from the data set retrieved from the database will be inserted into a FirstName field on the PDF template. Once all data is filled, a completed document is returned to the user's browser where the user can view the document 208.

Documents that are generated and are accepted as a final version for a particular client, (depending on what part of the system was used to generate it) are stored in a document storage and retrieval database for later viewing. When a document is stored in the document storage, it is stored with a unique document id. Such document id is stored with the client's information in the database. The document id is used by the system to retrieve a selected document from the document storage and retrieval system at a later time when a user requests to view the document again. The document generation engine component can produce a complete package of bankruptcy documents that can be filed in court.

When an attorney closes a case for a client, an entire package of documents is stored in an external image system. Such package can be retrieved from such external image system by using a message queue that handles requests between multiple servers, as schematically shown in FIG. 67. A user, such as an attorney selects a case to be reviewed at step 211. A request is received by the system and is passed to a document retrieval component 214 of system software. The document retrieval component 214 sends a request to a message queue 216 identifying the particular case to be retrieved. Once the message reaches the top of the queue, the identified bankruptcy case is fetched from the external image system 219. The stored case is returned to the user through the message queue 216. An attorney can access client files for closing or archiving by way of a ‘manage clients’ link 222 (FIG. 58).

It will be appreciated by persons skilled in the art that numerous variations and/or modifications may be made to the invention as shown in the specific embodiments without departing from the spirit or scope of the invention as broadly described. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein. The present embodiments are, therefore, to be considered in all respects as illustrative and not restrictive.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein.

[image]

[image]

[image]

[image]

[image]

[image]

[image]

[image]

[image]

[image]

[image]

[image]

[image]

[image]

[image]

What is claimed is:

1. A method for rendering financial counseling services over a global computer network, such method comprising the steps of:
a. receiving information concerning a debtor's financial condition;
b. evaluating such debtor's financial condition;
c. recommending a course of action to improve such debtor's financial condition; and
d. providing means for generating forms for filing for bankruptcy.

2. The method according to claim 2, wherein:
a. such global computer network comprises the Internet.

3. The method according to claim 1, wherein such step for receiving information concerning a debtor's financial condition further comprises:
a. such debtor inputting personal data;
b. such debtor inputting income data;
c. such debtor inputting expenses data; and
d. such debtor inputting debt data.

4. The method according to claim 3, further comprising:
a. maintaining security of such debtor input personal information, income information, expense information and debt information.

5. The method according to claim 1, wherein such step for evaluating such debtor's financial condition further comprises:
a. calculating such debtor's total income;
b. calculating such debtor's total expenses;
c. calculating such debtor's total debt;
d. calculating such debtor's disposable income; and
e. comparing such debtor's disposable income to such debtor's total debt.

6. The method according to claim 5, further comprising:
a. calculating such debtor's solvency;
b. calculating such debtor's qualification for a 36-month debt recovery plan;
c. calculating such debtor's qualification for a 60-month debt recovery plan; and
d. calculating such debtor's qualification for an attorney assisted settlement plan.

7. The method according to claim 1, wherein such step for recommending a course of action to improve a debtor's financial condition is selected from the group consisting of:
a. if such ratio of disposable income to total debt is greater than or equal to a first predefined parameter, recommend maintaining current financial course of action;
b. if such ratio of disposable income to total debt is between a second predefined parameter and such first predefined parameter, recommend complete financial analysis and debt management counseling;
c. if such ratio of disposable income to total debt is less than or equal to such second predefined parameter, recommend complete financial analysis and credit counseling for bankruptcy consideration; and
d. recommend filing for bankruptcy.

8. The method according to claim 7, wherein:
a. such first predetermined parameter is a percentage; and
b. such second predetermined parameter is a percentage.

9. The method according to claim 8, further comprising:
a. providing a database containing predetermined form paragraphs selected from the group consisting of:
(1) paragraphs describing exempt property;
(2) paragraphs describing credit counseling;
(3) paragraphs describing debt management plans;
(4) paragraphs describing attorney assisted settlement; and
(5) paragraphs describing bankruptcy filing;
b. selecting at least one predetermined form paragraph based on such debtor's recommended course of action; and
c. creating an analysis document from such selected at least one predetermined form paragraph.

10. The method according to claim 1, further comprising:
a. enabling a debtor to subscribe to such system for a fee; and
b. enabling an attorney to subscribe to such system for a fee.

11. The method according to claim 1, wherein such step for providing means for generating forms for filing for bankruptcy further comprises:
a. providing a database containing templates of bankruptcy forms;
b. identifying a debtor associated with such bankruptcy filing;
c. selecting a bankruptcy form to be generated from such database of templates;
d. generating a document image for such form;
e. populating such document image with selected data associated with such identified debtor; and
f. creating a document from such bankruptcy form template having such debtor data incorporated in such document.

12. A system for rendering financial counseling services over a global computer network, such system comprising:
a. means for a debtor to input such debtor's financial information;
b. means for receiving such debtor's financial information;
c. a first database for storing such debtor's financial information;
d. means for evaluating such debtor's financial condition;
e. means for recommending a course of action to improve such debtor's financial condition; and
f. means for generating forms for filing for bankruptcy.

13. The system according to claim 12, wherein:
a. such input means, receiving means, evaluating means, generating means and means for recommending a course of action comprise computing means.

14. The system according to claim 12, wherein:
a. such global computer network comprises the Internet.

15. The system according to claim 14, further comprising:
a. means for maintaining security of such debtor input personal information, income information, expense information and debt information.

16. The system according to claim 12, wherein such debtor's financial information comprises:
a. personal data;
b. income data;
c. expenses data; and
d. debt data.

17. The system according to claim 16, wherein such debtor's financial information further comprises:
a. co-debtor's personal data;
b. co-debtor's income data;
c. co-debtor's expenses data; and
d. co-debtor's debt data.

18. The system according to claim 12, further comprising:
a. means for calculating such debtor's total income;
b. means for calculating such debtor's total expenses;
c. means for calculating such debtor's total debt;
d. means for calculating such debtor's disposable income; and
e. means for comparing such debtor's disposable income to such debtor's total debt.

19. The system according to claim 18, wherein:
a. such means for calculating such debtor's total income;
b. such means for calculating such debtor's total expenses;
c. such means for calculating such debtor's total debt;
d. such means for calculating such debtor's disposable income; and
e. such means for comparing such debtor's disposable income to such debtor's total debt comprise computer means.

20. The system according to claim 18, further comprising:
a. means for calculating such debtor's solvency;
b. means for calculating such debtor's qualification for a 36-month debt recovery plan;
c. means for calculating such debtor's qualification for a 60-month debt recovery plan; and
d. means for calculating such debtor's qualification for an attorney assisted settlement plan.

21. The system according to claim 21, wherein:
a. such means for calculating such debtor's solvency;
b. such means for calculating such debtor's qualification for a 36-month debt recovery plan;
c. such means for calculating such debtor's qualification for a 60-month debt recovery plan; and
d. such means for calculating such debtor's qualification for an attorney assisted settlement plan comprise computing means.

22. The system according to claim 12, further comprising:
a. a second database containing predetermined form paragraphs selected from the group consisting of:
(1) paragraphs describing exempt property;
(2) paragraphs describing credit counseling;
(3) paragraphs describing debt management plans;
(4) paragraphs describing attorney assisted settlement; and
(5) paragraphs describing bankruptcy filing;

23. The system according to claim 12, further comprising:
a. a third database containing templates of bankruptcy forms;
b. means for selecting a bankruptcy form to be generated from such database of templates;
c. means for identifying a debtor to associate with a form selected from such third database;
d. means for populating such bankruptcy form with selected data associated with such identified debtor; and
e. means for creating a document from such bankruptcy form template having such debtor data incorporated in such document.

24. The system according to claim 12, such system further comprising:
a. means for listing an attorney in an on-line directory listing, such means including:
(1) such attorney's name;
(2) courts such attorney is licensed to practice;
(3) years experience;
(4) professional associations;
(5) office address;
(6) phone number; and
(7) contact information; and
b. means for displaying a profile for such attorney.

25. The system according to claim 12, further comprising:
a. means for purchasing licenses on-line.

26. The system according to claim 12, further comprising:
a. means for assigning licenses purchased on-line.

27. The system according to claim 12, further comprising:
a. means for communicating such assigned license to a debtor.

28. The system according to claim 27, wherein such means for communicating such assigned license to a debtor is selected from the group consisting of:
a. telephone;
b. in person;
c. e-mail; and
d. postal mail.

29. The system according to claim 12, further comprising:
a. means for secure two-way message communication between an attorney and an assigned licensee.
